(19) United States
(12) Patent Application Publication
(10) Pub. No.: US 2003/0069759 A1
(43) Pub. Date: Apr. 10, 2003

(54) Health care management method and system

(75) Inventor: Kevin L. Smith, Kingston, NY (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: MDoffices.com, Inc.

(21) Appl. No.: 10/262,773

(22) Filed: Oct. 2, 2002

Related U.S. Application Data
(60) Provisional application No. 60/326,859, filed on Oct. 3, 2001.

(51) Int. Cl. G06F 17/60

(52) U.S. Cl. 705/3

(57) ABSTRACT

A health care management method and system are used to relieve health care personnel of the burden of administrative, regulatory and reimbursement tasks which distract them from practicing medicine. The system includes a central database and at least one portable user interface device. The central database stores a plurality of medical records associated with a plurality of patients. The portable user interface device includes a display and a memory. A subset of the plurality of medical records is stored in the memory of the portable user interface device. The portable user interface device presents on the display a plurality of selectable windows including at least one activity initiation window for ordering health care activities associated with a selected patient and an activity status window for presenting a list of the ordered health care activities and the status of each ordered health care activity.

### CROSS-REFERENCE TO RELATED APPLICATIONS

This application claims the benefit of U.S. Provisional Application No. 60/326,859, filed Oct. 3, 2001, entitled “Clinically Intuitive User Interface For Multimedia Wireless Handheld Computers,” which is incorporated herein by reference in its entirety.

### BACKGROUND OF THE INVENTION

Doctors have been accustomed to simple, standard medical records that they have used since attending medical school. Presently, only 1% or 6,000 U.S. physicians are using handheld devices for transactional purposes, and the ones being used are limited to only a few basic functions, such as preparing drug prescriptions.

According to the November 1999 Goldman Sachs eHealthcare Report, waste and inefficiency in healthcare is estimated to be between $250 billion and $300 billion per year. A single doctor's office employing three ancillary staff members can spend over 120 hours a week on non-clinical tasks. Except for billing, most of these tasks are done by handwriting on paper, which requires a cumbersome medical record filing system. In addition, significant amounts of time are wasted finding, pulling, copying and re-filing records. Both physicians and healthcare organizations must replace their paper-based systems to save time, reduce medical errors and cut expenses.

Currently, the vast majority of physician duties are manual, disjointed tasks. Physicians spend approximately 45%-60% of their work time on such tasks. For example, just one task of ordering and filling a prescription can involve several feedback loops and hand-off procedures that may consume an excessive amount of the doctor's time, and can create several opportunities for transaction errors. The same holds true for clinical documentation, diagnostic studies, consultation requests and claims generation.

A 1999 Institute of Medicine (IOM) report estimates that approximately 98,000 patients die every year due to medical errors, and also estimates that the total national costs of preventable, adverse events are between $17 billion and $29 billion per year. According to the IOM, errors occur because the health care industry is complex, with a high degree of specialization, interdependency and multiple feedback loops. Medical personnel also cause errors by exchanging clinical information between each other without verifying the accuracy of the exchange. One of the key recommendations of the IOM report states that “the likelihood of accidents can be reduced by making systems more reliable and safe—simplifying and standardizing processes, building in redundancy, developing backup systems, etc.”

Security and privacy issues in the healthcare industry also continue to be of great concern. Confidential medical information in the hands of the wrong people has long been a major issue in healthcare. Furthermore, industry standards require all medical professionals to keep medical records in a locked and secure environment.

Technology is needed to save physicians time and money by conveniently outsourcing clinical documentation, treatment plan execution, and the management of sensitive data. Doctors must adopt technology solutions that minimize their non-clinical work, maximize the number of patients that they can see each day, and enhance their overall opportunity to concentrate on clinical issues. Such technology assists doctors in transitioning to electronic, paperless systems that easily automate regulatory compliance and standards.

### BRIEF SUMMARY OF THE INVENTION

The present invention converts one clinical action by the doctor into six primary outcomes. By integrating advanced voice recognition with mobile and Internet technologies into a quick and easy point-of-care service, the doctor's clinical documentation is captured on a multimedia wireless handheld device, deciphered into a medical record and treatment plan, the prescribed treatment plan is executed, and the results are retrieved and returned as instant messages on the doctor's handheld device. The present invention includes the following features:

(1) Task List;

(2) Reminder Notice;

(3) Clinical Action Menus;

(4) Wrap Up;

(5) Tracking Functionality;

(6) Handheld Device/Service Provider Integration;

(7) Medical Record Security and Privacy;

(8) Fax/Optical Character Recognition (OCR);

(9) Data Subset Synchronization; and

(10) Transcription Services.

In accordance with preferred embodiment of the present invention, a computer-implemented method is used in a health care management system including a central database and at least one portable user interface device. The central database stores a plurality of medical records associated with a plurality of patients. The portable user interface device includes a display and a memory. A subset of the plurality of medical records is stored in the memory of the portable user interface device. The portable user interface device presents on the display a list identifying the patients associated with the subset of medical records. One of the medical records stored in the memory is opened by selecting a patient from the list. A plurality of selectable windows are presented on the display of the portable user interface device including (i) at least one activity initiation window for ordering health care activities associated with the selected patient and (ii) an activity status window for presenting a list of the ordered health care activities and the status of each ordered health care activity. After the subset of medical records is stored in the portable user interface device, a user is able to manage health care activities performed for the patients associated with the subset of medical records without having to further communicate with the central database.

The memory of the portable user interface device may be used to update data in the central database. The health care activities may include placing an order for a prescription, a diagnostic study, a diet, supplies, or a laboratory test. The health care activities may also include specifying a consultant to consult with the patient or sending a notification to a health care provider. The user may post a reminder in the activity status window to complete a task at a future time. An indicator may be automatically presented on the display reminding the user to complete a task at a future time. The user may modify the contents of the medical records stored in the memory by making menu selections and/or entering data on one or more of the selectable windows. Access to specific portions of the medical records may be controlled based on criteria specified by at least one of the users and the respective patients.

An ordered health care activity may remain on the list until it is verified by the user that the activity has been completed. The status may be that information required to order a health care activity has not been completed, an order for a health care activity has been completed but not yet released from the portable user interface device, an order for a health care activity has been released from the portable user interface device but no results have been returned to the portable user interface device, only a portion of an ordered health care activity has been completed, an ordered health care activity has been completed, or an ordered health care activity has been cancelled. The user may control the portable user interface device to toggle between different ones of the selectable windows presented on the display.

In one embodiment of the present invention, a computer-implemented method is used in a health care management system including a central database, a plurality of synchronization servers and a plurality of portable user interface devices. The central database stores a plurality of medical records associated with a plurality of patients. Each of the portable user interface devices includes a memory and is in communication with only one of the synchronization servers. A different subset of the plurality of medical records is distributed from the central database to each of the synchronization servers. Each of the synchronization servers stores and refreshes at least a portion of the subset in the memory of the portable user interface device that is currently in communication with the respective synchronization server.

In another embodiment of the present invention, a computer-implemented method is used in a health care management system including a central database, a voice recognition system including a first queue, a transcription service node having a second queue and at least one portable user interface device including a memory. A voice file is created using the portable user interface device. The voice file is sent to the voice recognition system and the voice file is stored in the first queue. The voice recognition system creates a text file based on the voice file. Both the text file and the voice file are placed in the second queue of the transcription node for manual processing by a transcriptionist. The transcriptionist edits the text file stored in the second queue based on the voice file. The edited text file is stored in a memory which is accessible by the portable user interface device.

A data file associated with the voice file may be sent to the voice recognition system. The data file may indicate the priority of the voice file. The edited text file may be used to train the voice recognition system to avoid errors corrected by the transcriptionist.

### BRIEF DESCRIPTION OF THE SEVERAL VIEWS OF THE DRAWING

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 shows a Task List screen in accordance with the present invention;

FIG. 2 shows a Reminder Notice screen in accordance with the present invention;

FIG. 3 shows a Clinical Action document menu screen in accordance with the present invention;

FIG. 4 shows a Clinical Action document record screen in accordance with the present invention;

FIG. 5 shows a Clinical Action document write screen in accordance with the present invention;

FIG. 6 shows a Clinical Action document photo screen in accordance with the present invention;

FIG. 7 shows a Clinical Action document file screen in accordance with the present invention;

FIG. 8 shows a Clinical Action diagnosis screen in accordance with the present invention;

FIG. 9 shows a Clinical Action diagnosis action menu in accordance with the present invention;

FIG. 10 shows a Clinical Action diagnosis selection screen in accordance with the present invention;

FIG. 11 shows a Clinical Action order menu in accordance with the present invention;

FIG. 12 shows a Clinical Action lab order screen in accordance with the present invention;

FIG. 13 shows a Clinical Action lab order selection screen in accordance with the present invention;

FIG. 14 shows a Clinical Action special lab order window in accordance with the present invention;

FIG. 15 shows a Clinical Action ordered studies screen in accordance with the present invention;

FIG. 16 shows a Clinical Action ordered studies selection screen in accordance with the present invention;

FIG. 17 shows a Clinical Action special studies order screen in accordance with the present invention;

FIG. 18 shows a Clinical Action ordered Rx screen in accordance with the present invention;

FIG. 19 shows a Clinical Action consultant screen in accordance with the present invention;

FIG. 20 shows a Clinical Action consultant selection screen in accordance with the present invention;

FIG. 21 shows a Clinical Action notification screen in accordance with the present invention;

FIG. 22 shows a Clinical Action notification selection screen in accordance with the present invention;

FIG. 23 shows a Clinical Action follow-up visit screen in accordance with the present invention;

FIG. 24 shows a Clinical Action follow-up visit selection screen in accordance with the present invention;

FIG. 25 shows a Clinical Action wrap up screen in accordance with the present invention;

FIG. 26 shows a Clinical Action wrap up code screen in accordance with the present invention;

FIG. 27 shows an accessibility of an application service provider over wireless, conventional networks and the Internet using handhelds, PCs and telephones;

FIG. 28 shows a Patient List displayed on a portable user interface device in accordance with the present invention;

FIGS. 29-33 show different selectable windows and interfaces displayed on a portable user interface device in accordance with the present invention;

FIG. 34 is a flow chart showing the method steps used in accordance with a preferred embodiment of the present invention;

FIG. 35 is a block diagram of a system that synchronizes subsets of data according to one embodiment of the present embodiment;

FIGS. 36-75 show block diagrams and flow charts related to a transcription process according to one embodiment of the present invention; and

FIG. 76 is a flow chart showing the method steps used to execute transcription services in accordance with one embodiment of the present invention.

### DETAILED DESCRIPTION OF THE INVENTION

The present invention is a totally integrated, clinically intuitive user interface for multimedia wireless handheld devices which “helps doctors be doctors again.” The present invention divests physicians of the administration, regulatory and reimbursement burdens that distract the physicians from the practice of medicine today.

The physician simply dictates his or her mandatory clinical note on the handheld device. At the point of care, the present invention enables the doctor to electronically authorize and schedule the execution of prescriptions, lab tests and consultation referrals, implement procedure and diagnosis coding, and generate claims and medical records. All clinical data is fed back to the doctor through instant messaging on the handheld device. All documentation required as a part of processing information inputted by the doctor is completed for the doctor. All outstanding information and unfinished tasks are tracked by the present invention, so that the doctor can be assured that his or her clinical and regulatory obligations are met. This enables the doctor to drastically slash the time required to review and analyze medical data and thus be able to make critical decisions immediately.

The doctor's only direct contact with technology is through a clinically intuitive portable user interface device designed in accordance with the present invention. The portable user interface device enables the doctor to take the “pulse” of the doctor's entire clinical practice just as easily as the doctor can assess each patient's condition. The doctor can perform quality assurance evaluations on the doctor's own clinical practice and confidentially compare the doctor's performance statistically against those of the doctor's peers. The availability of this information translates into more time for patients, better medicine, lower operational costs, and increased revenue for the doctor. Better medical practice translates into better performance by all of the major health industry players who practice the present invention.

The doctor may access his or her virtual office from any location securely over wireless, conventional networks and the Internet using handheld devices and PCs. Furthermore, the present invention integrates with legacy applications resident in the doctor's office or hospital, and supports migration of paper-based systems into future, mandated standardized medical data repositories.

The present invention is presented as a simple, standard medical record that doctors have been accustomed to using since medical school. The user interface appears as a medical chart that is bound along the top, with tab dividers along the bottom that “lift up” as you navigate the chart. The present invention includes many technological features.

(1) Task List

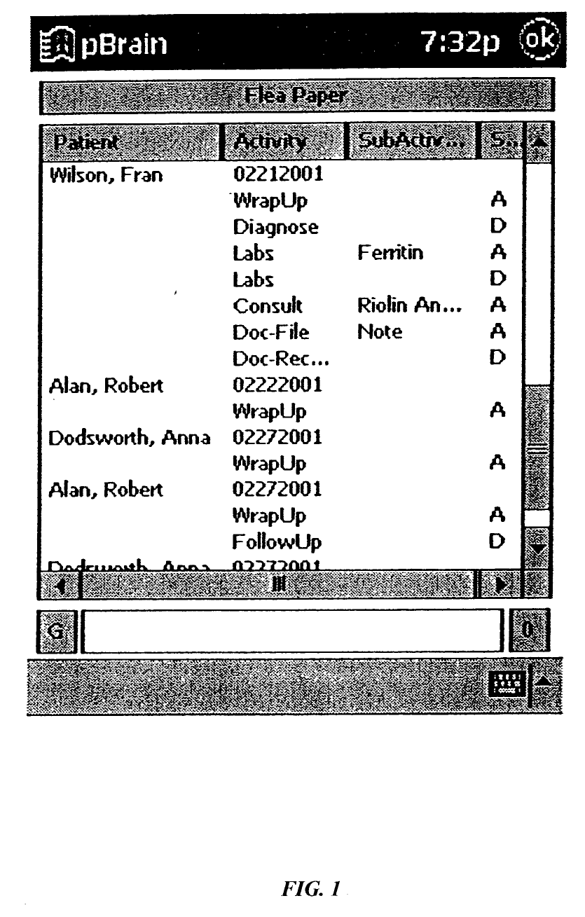

As shown in FIG. 1, the Task List (referred to as Flea Paper™ in the Appendix) automatically provides a professional, such as a doctor, with a unique, highly functional and clinically intuitive feature. The task list tracks work that has not yet been completed, the work that is expected to be received from other parties (e.g., healthcare providers, labs, consultants, or the like), and a status report on just where that work stands. It may be organized by patients' last names and by dates of service (DOS). For example, if Mr. Frank Jones was seen on Feb. 12, 2001 and Feb. 13, 2001, and Mrs. Emily Kristt was seen on Feb. 12, 2001, and there is still outstanding work associated with the respective patients that needs to be completed, they are listed as:

| | |
|---|---|
| Jones, Frank | 02122001 |
| Jones, Frank | 02132001 |
| Kristt, Emily | 02122001 |

Once all outstanding work associated with a particular patient is completed, that patient's name and DOS is automatically removed from the Task List.

The Task List includes the headers “Patient,” “Activity,” “SubActivity,” and “S” (Status). Each header has a sort functionality when toggled. The “Patient” column contains a list of all patients with unfinished work. The “Activity” column contains the DOS and a list of categories for which there remains unfinished work to be done. The “SubActivity” column contains a list of unfinished work. For example, the “Activity” Labs would be associated with “SubActivity” Sodium, Potassium, CBC and SGGT. The “S” column shows the status of the unfinished work using the following codes:

(1) D=deferred, meaning that the doctor has not yet finished his or her work on a particular task.

(2) A=awaiting synchronization, meaning that a particular task is still sitting on the handheld device waiting to be sent to a service provider for execution.

(3) P=pending, meaning that a particular task has been sent to a service provider for execution, but no results have yet been returned.

(4) R=received, meaning that results of a particular task have been received from a service provider and are awaiting review.

(5) PR=partially received, meaning only a portion of results of a series of tasks placed to a service provider have been received.

(6) C=cancelled, meaning that a task order has been terminated.

Clicking on any item listed under “Activity” or “SubActivity” causes the handheld device to display the details of that item. All ordered tasks remain on the Task List until they have been received and electronically signed off by the user. Upon being electronically signed off, the respective order tasks are automatically removed from the Task List.

(2) Reminder Notice

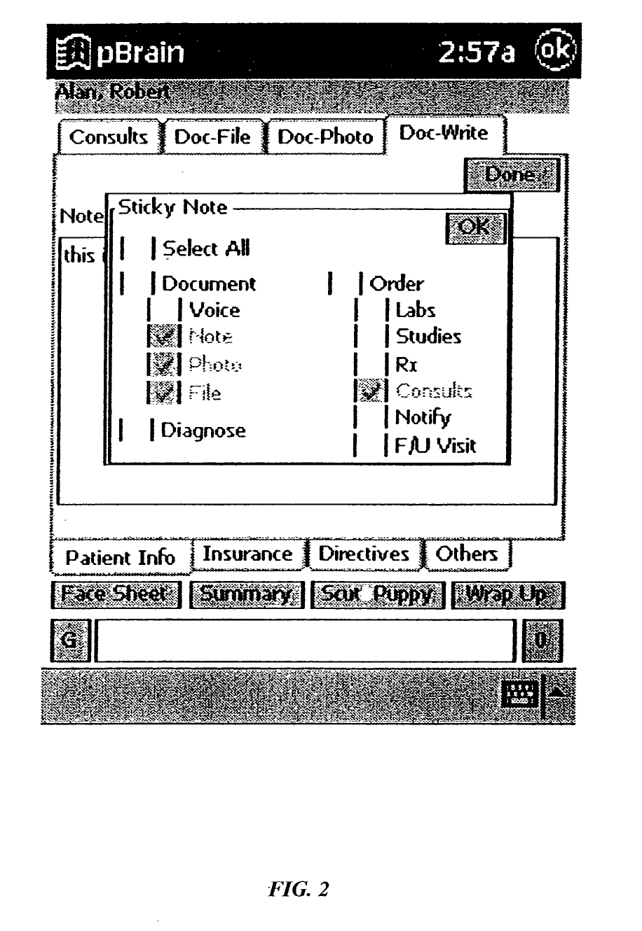

As shown in FIG. 2, a Reminder Notice (referred to as a StickyNote in the Appendix) may be placed on the Task List to remind the user to complete a particular task associated with a particular patient at a later time. An applet is used to generate the Reminder Notice in response to clicking on the patient's name in the top left-hand corner of the patient's medical record. For example, if the user is at dinner with friends and receives a call from his or her answering service stating that Mrs. Quigley needs a refill on her Cardizem before her next appointment, the user can simply click an “Rx” reminder on the Reminder Notice for Mrs. Quigley, and it is posted to the Task List as a reminder to submit a prescription when it is more convenient.

(3) Clinical Action Menus

As shown in FIG. 2, an action key (referred to as a Scut Puppy™ action key in the Appendix) provides the doctor with an opportunity to execute actions from anywhere within a patient's summary record by presenting a series of Clinical Action Menus. For example, if the doctor is reviewing a patient's Rx history and the doctor decides to write a new prescription, all the doctor has to do is activate an Rx order menu and a prescribing screen is presented. If the doctor is distracted in the process, and needs to go back and look once again at the Rx history, all the doctor needs to do is click on a “Summary” tab.

Bookmarks are automatically created in the medical record. Once the doctor opens a Clinical Action Menu, a tickler file tab is automatically maintained at the top of the screen as a reminder to the doctor that a Clinical Action Menu was opened but not completed. No clinical action is completed and ready for execution until after clicking “Done” in the upper right-hand corner of that tickler file tab window. As long as the tickler file tab window remains present, the Task List maintains an entry for that patient visit marked with Status “D” for deferred. This indicates that the doctor has not yet finished work on that clinical action. This redundancy helps to reduce the possibility of medical errors of omission or commission.

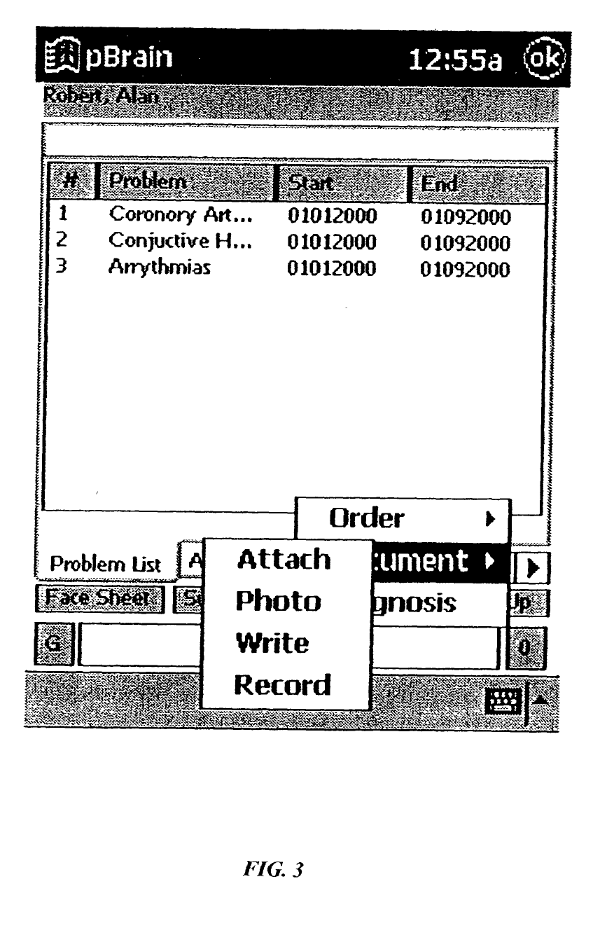

As shown in FIG. 3, a Clinical Action Menu entitled “Document” used to create clinical documentation is organized into four (4) functional categories: “Record,” “Write,” “Photo,” “Attach.”

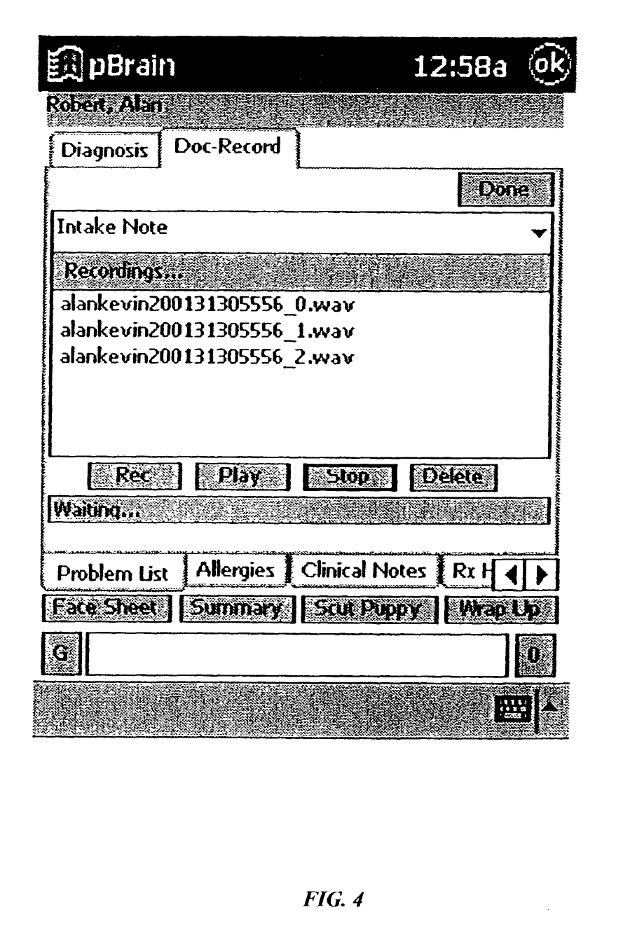

As shown in FIG. 4, the “Record” function allows the doctor to dictate clinical notes. The “Doc-Record” screen keeps a list of all recordings that have been made for a particular patient's visit. Each recording is automatically assigned a unique identifier, followed by “_n.wav,” where “n” is the number of the recording for that visit, and “wav” is the file format. There are four (4) recorder control keys at the bottom of the Doc-Record screen: “Rec” for recording the doctor's dictation; “Play” for playing back the dictation; “Stop” for stopping the recording; and “Delete” for deleting the entire recording. Beneath the four recorder control keys is an indicator bar that indicates what the recorder is doing. The indicator bar may indicate “Waiting” when the recorder is in a standby mode or when the “Stop” or “Delete” control keys are pressed. The indicator bar may also indicate “Recording” when the recorder is in the record mode, and “Playing” when the recorder is playing back a highlighted wav file.

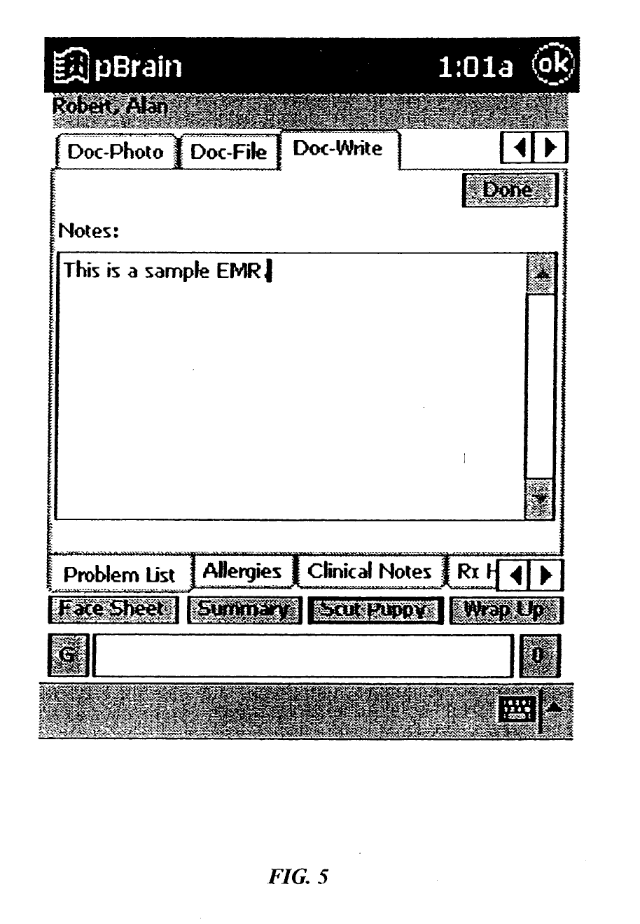

As shown in FIG. 5, the “Write” function allows the doctor to write clinical documentation using a keyboard or character recognizer located at the bottom right-hand corner of the screen.

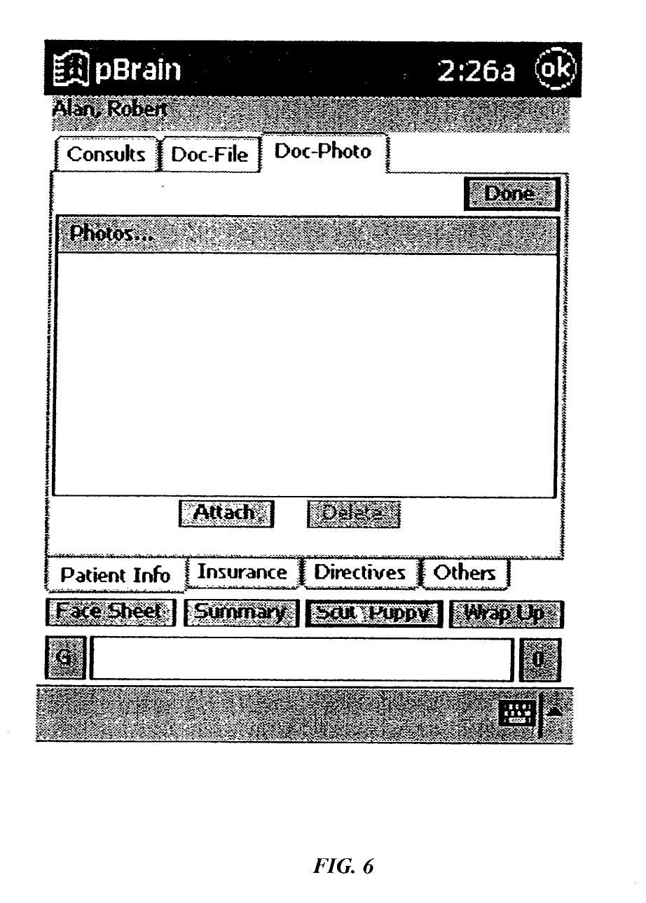

As shown in FIG. 6, the “Photo” function allows the doctor to capture a digital photograph with the handheld device and incorporate the photo directly into a particular patient's medical record. The handheld device uses digital photography with an optional camera which is inserted into a Flash Card port attaches at the top of the handheld device. There are two control keys at the bottom of the Doc-Photo window: “Attach” which allows a photo file to be attached to a particular patient's file, and “Delete” which allows a doctor to delete a photo already attached to a particular patient's file.

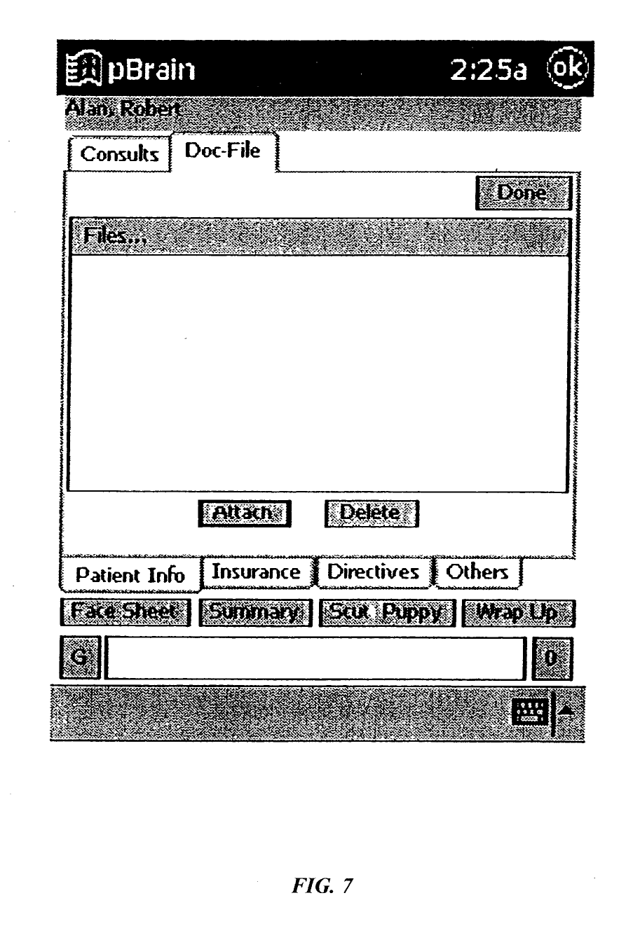

As shown in FIG. 7, the “Attach” function allows the doctor to attach an electronic file, such as an e-mail received from a service provider, directly to a particular patient's medical record. There are two control keys at the bottom of the Doc-Attach window: “Attach” which allows a data file to be attached to a particular patient's file, and “Delete” which allows a doctor to delete a data file already attached to a particular patient's file.

Prior to creating clinical documentation, the doctor selects the type of document being created from the group consisting of: “Intake Note,” “Progress Note,” “Admission H&P,” Pre-Op Note,” “Post-Op Note,” “Discharge Note,” and “Photo Description.”

The four functions described above may be used individually or in combination. All entries are captured as a part of a particular patient's visit. For example, a doctor may want to do a Pre-Op Note, a Post-Op Note, a Photo Description, a Photo of the patient's surgical wound, and attach a checklist file of the patient's past medical history that the patient filled out and e-mailed to the doctor prior to the patient's visit. The doctor may desire to include in the record a diagnosis and treatment plan for the patient. However, the handheld device automatically creates “Assessment” and “Plan” sections of the clinical documentation from the information obtained from the Clinical Action Menus.

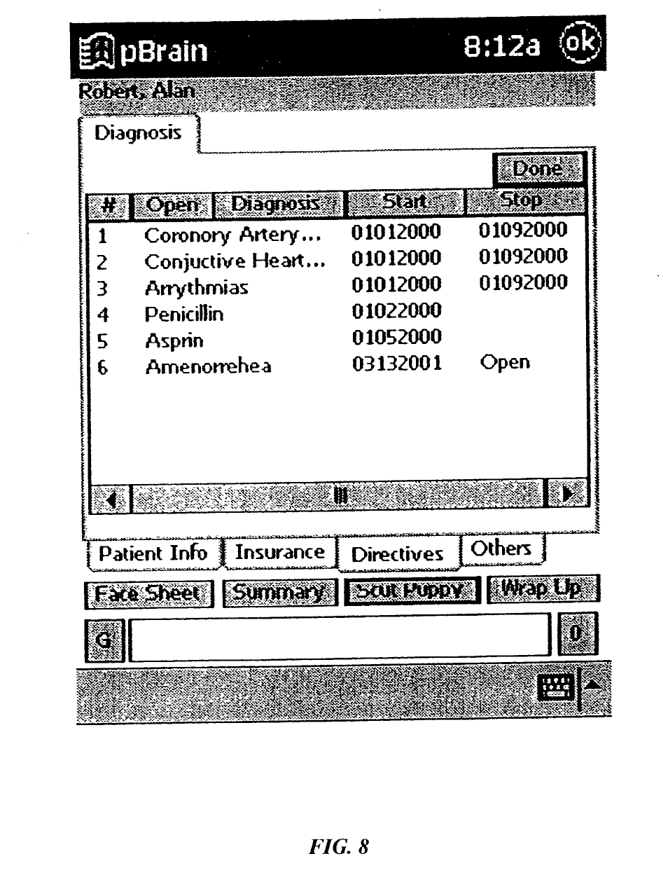

As shown in FIG. 8, a Clinical Action Menu option entitled “Diagnosis” is used by the doctor to record selected diagnoses for a particular patient during a visit. Diagnoses may be displayed based on whether they are currently being treated (“Open”), are currently listed in a particular patient's file (“All”), or are related to a particular organ system (e.g., cardiovascular). The date that a diagnosis was first made and the date that it was resolved are also displayed.

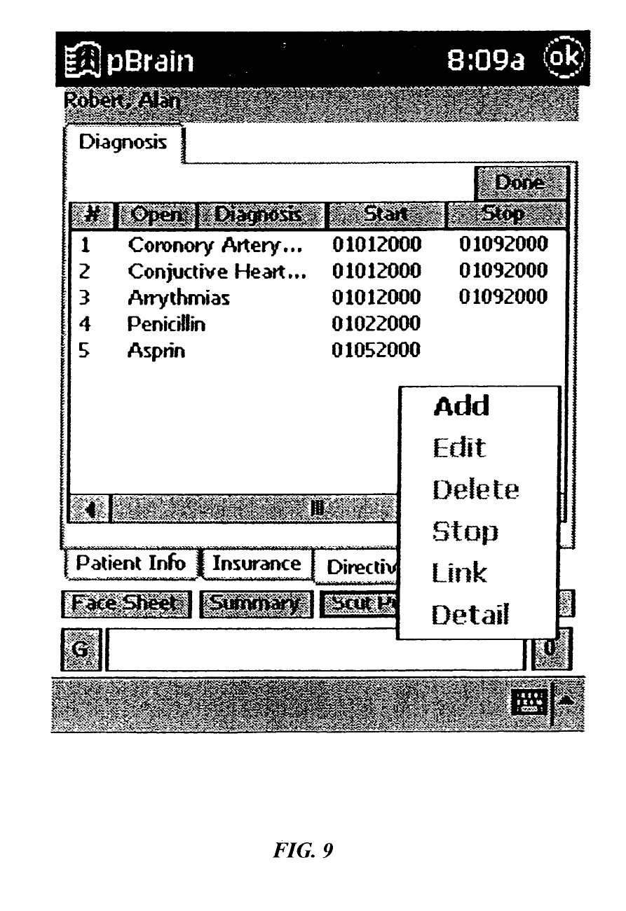

As shown in FIG. 9, an action menu on the screen may be activated to provide the following menu options:

(1) “Add” to add a new diagnosis;

(2) “Edit” to edit a highlighted diagnosis;

(3) “Del” to delete a highlighted diagnosis;

(4) “Stop” to stop the highlighted diagnosis;

(5) “Link” to link the highlighted diagnosis to a new diagnosis; and

(6) “Detail” to show more detail about the highlighted diagnosis.

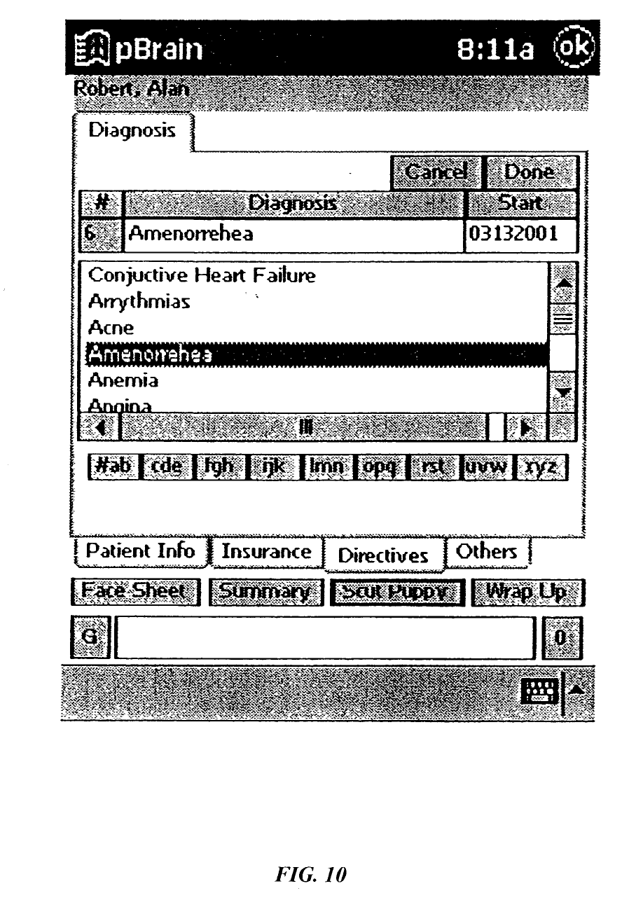

As shown in FIG. 10, the “Add” menu option opens a diagnosis selection screen. When a new diagnosis is selected, it is automatically assigned a new problem number and start date, and added to the Diagnosis list.

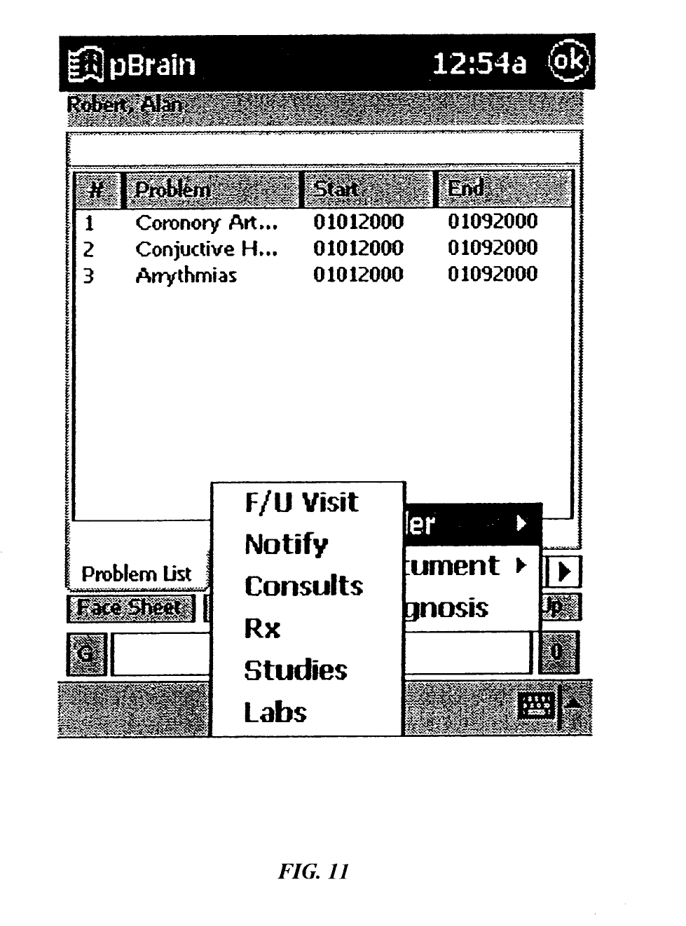

As shown in FIG. 11, a Clinical Action Menu entitled “Order” is used to submit orders and/or documents to one or more service providers. The Order Clinical Action Menu is organized into six (6) functional categories: “Labs,” “Studies,” “Rx,” “Consults,” “Notify,” and “F/U Visit” (follow-up visit). Additional categories including “Supplies” and “Diets” may be incorporated into the Clinical Action Menu.

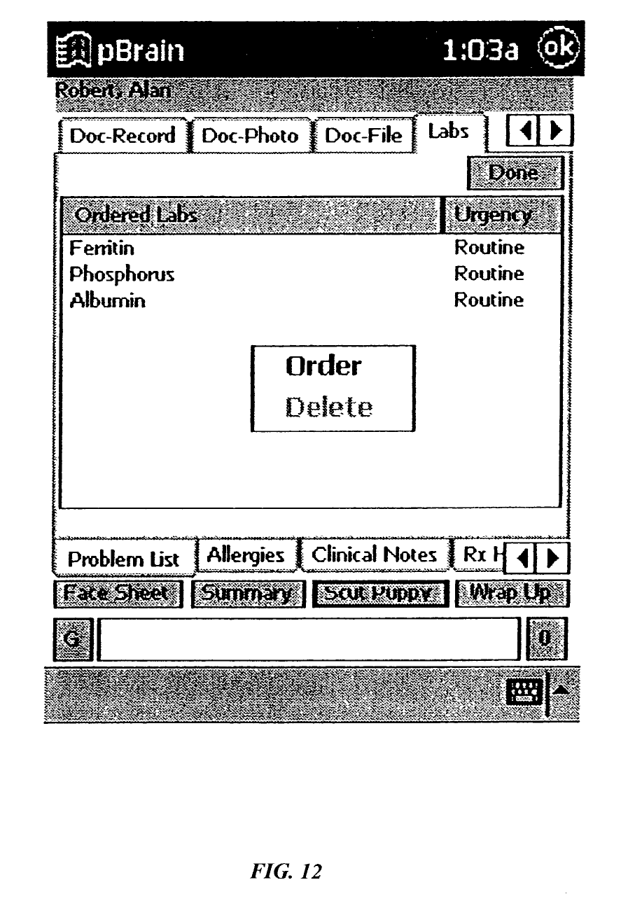

As shown in FIG. 12, the “Labs” screen lists any lab tests ordered during a particular patient's visit. When the screen is opened for the first time during the visit, it does not show any lab tests on the list. Clicking on the blank screen causes the following Clinical Action Menu options to pop up: “Order” which brings up a list of lab results to select from for adding to the doctor's Ordered Labs list, and “Delete” which allows the doctor to delete any test highlighted on the Ordered Labs list.

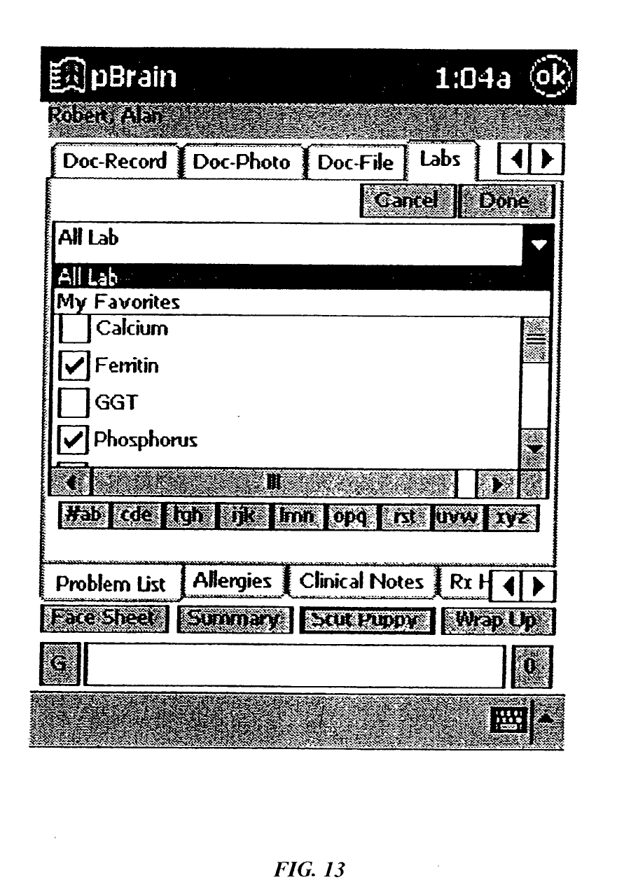

As shown in FIG. 13, when adding to the list of lab tests, a Labs selection window opens. This window has a column header for sorting lab tests as follows;

(1) “Favorites” for self-selected tests;

(2) “All” for all available lab tests;

(3) “Bacteriology”;

(4) “Blood Bank”;

(5) “Chemistry”;

(6) “Cytology”;

(7) “Hematology”; and

(8) “Pathology”.

The numerous lab tests can be quickly navigated by using the standard alphabetical keys located beneath the list or the scroll bar on the right-hand side of the screen. To select a test, the box next to the test's name is clicked on.

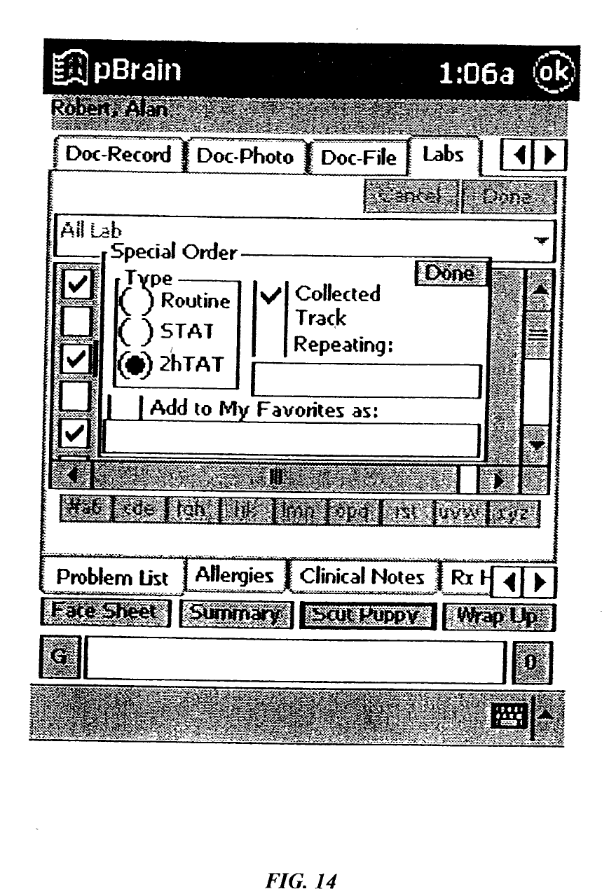

As shown in FIG. 14, clicking directly on the name of the lab test that the doctor checks off for ordering causes a Special Order window to pop up. The Special Order window allows the doctor to make the following selections for an ordered test:

(1) “Type”: the urgency or rapidity at which the test is to be completed. The “Type” options are:

(a) “STAT” (within a one-hour turn-around time);

(b) “2hTAT” (within a two-hour turn-around time); and

(c) “Routine” (within the lab's routine turn-around time).

(2) “Collected”: a specimen has already been collected. Entries including procedure codes for the specimen collection are automatically posted to a Code list.

(3) “Track”: the test is tagged for tracking longitudinally in graphic format.

(4) “Repeating”: repeating requests for previously requested lab tests are sent at an interval specified in a box just below the word “Repeating.”

(5) “Add to My Favorites as”: is an optional feature that adds to a Favorite Labs sort list to the Special Order so that the doctor does not have to re-create it every time it is re-ordered. A box below the “Add to My Favorites as” label allows the doctor to give the Special Order a unique name. For example, electrolytes performed STAT every two hours during routine dialysis might be named “Lytes Dialysis.”

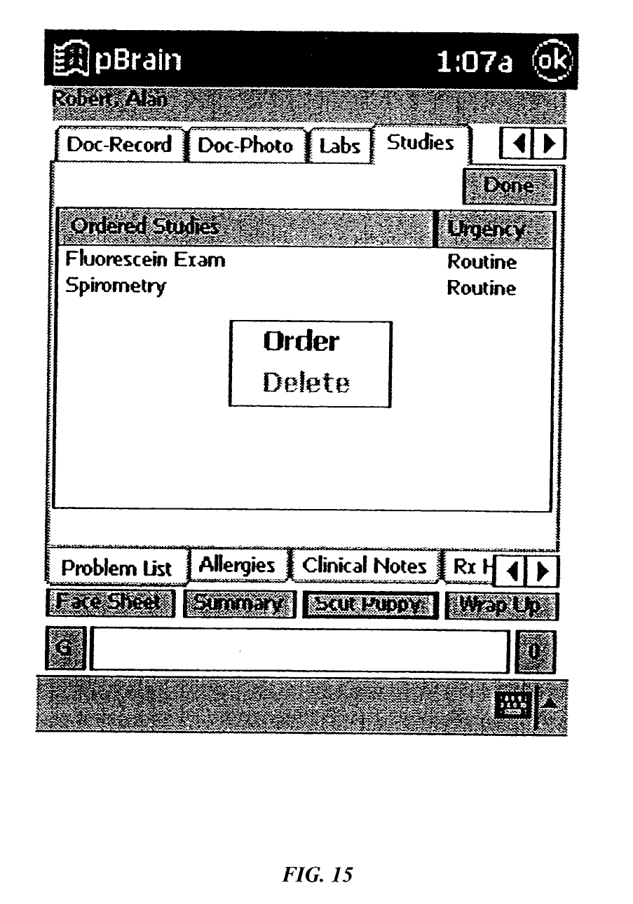

As shown in FIG. 15, the “Study” screen lists any diagnostic studies ordered during a particular patient's visit. When the screen is opened for the first time during the visit, it does not show any studies on the list. Clicking on the blank screen causes the following Clinical Action Menu options to pop up: “Order” which brings up a list of studies to select from for adding to the doctor's Ordered Studies list, and “Delete” which allows the doctor to delete any study highlighted on the Ordered Studies list.

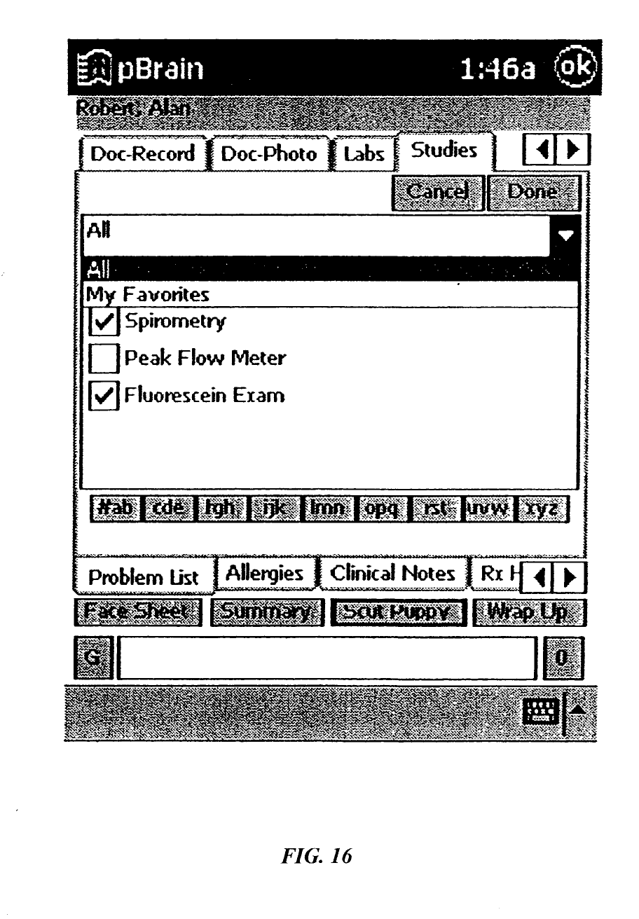

As shown in FIG. 16, when adding to the list of studies, a Studies selection window opens. This window has a column header for sorting studies as follows:

(1) “Favorites” for self-selected studies; and

(2) “All” for all available diagnostic studies.

The numerous diagnostic studies can be quickly navigated by using the standard alphabetical keys located beneath the list or the scroll bar on the right-hand side of the screen. To select a study, the box next to the study's name is clicked on.

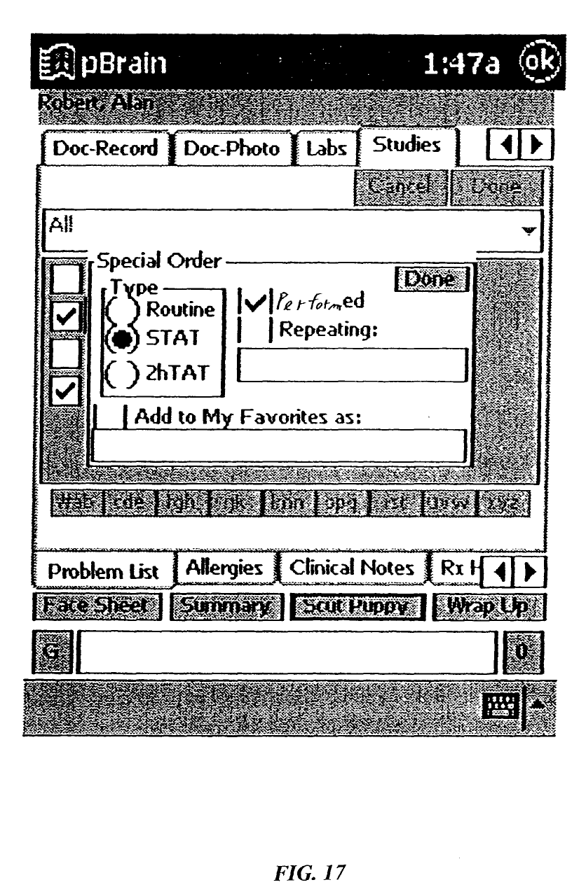

As shown in FIG. 17, clicking directly on the name of the study that the doctor checks off for ordering causes a Special Order window to pop up. The Special Order window allows the doctor to make the following selections for an ordered test:

(1) “Type”: the urgency or rapidity at which the test is to be completed. The “Type” options are:

(a) “STAT” (within a one-hour turn-around time);

(b) “2hTAT” (within a two-hour turn-around time); and

(c) “Routine” (within the provider's routine turn-around time).

(2) “Performed”: the study has already been performed. Entries including procedure codes for the performed study are automatically posted to a Code list.

(3) “Repeating”: repeating requests for previously requested studies are sent at an interval specified in a box just below the word “Repeating.”

(4) “Add to My Favorites as”: is an optional feature that adds a Favorite Studies sort list to the Special Order so that the doctor does not have to re-create it every time it is re-ordered. A box below the “Add to My Favorites as” label allows the doctor to give the Special Order a unique name. For example, daily EKGs for three days for a possible heart attack might be named “EKG r/o MI.”

(5) “Confidential”: controls access to “Orders,” “Documentation,” and/or “Diagnoses” placed using an action key.

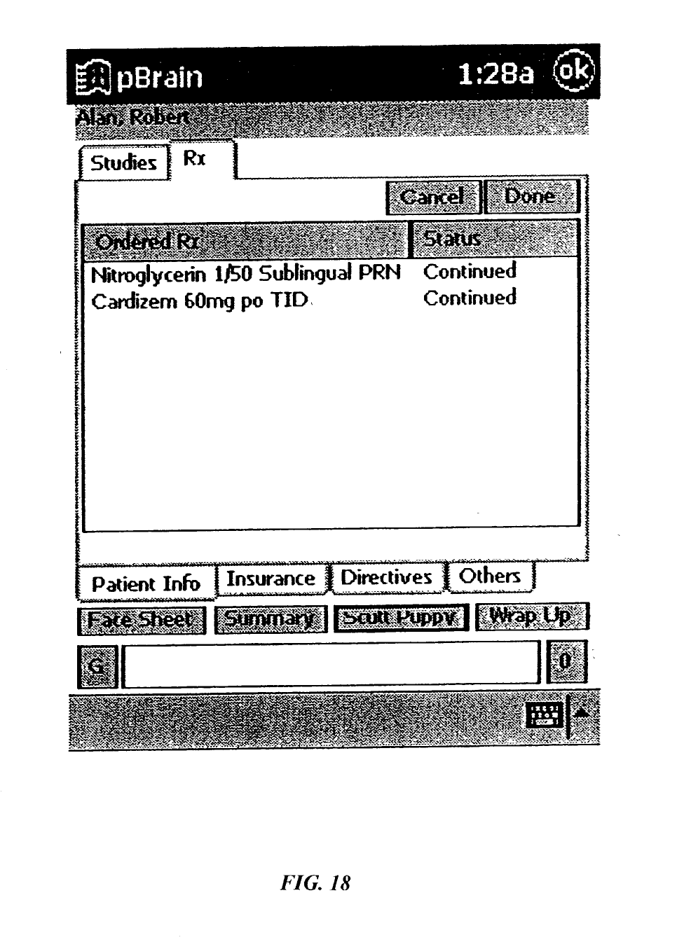

As shown in FIG. 18, prescriptions (Rx) may be ordered directly from a service provider through the handheld device.

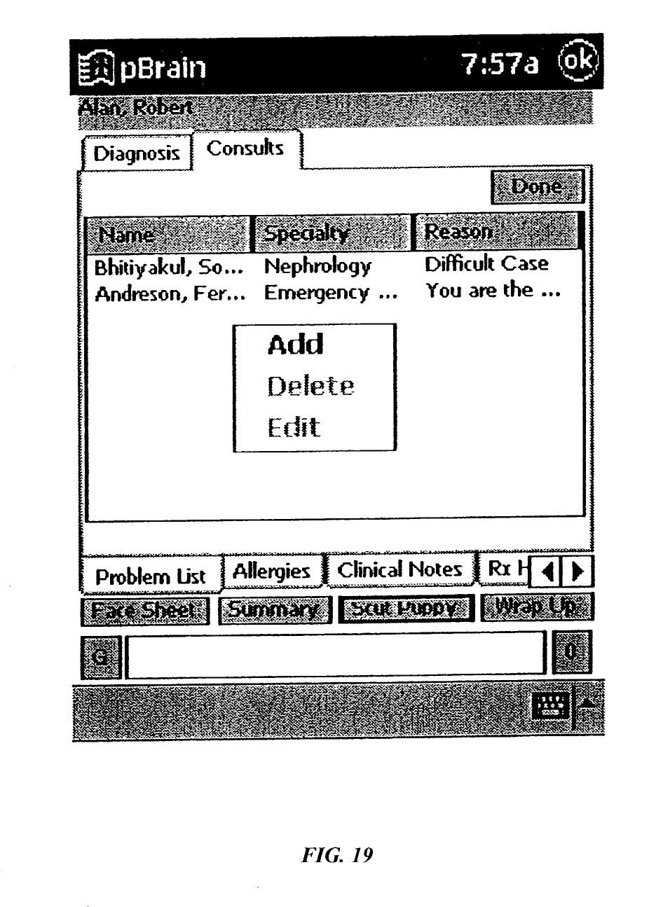

As shown in FIG. 19, Consults may be requested from the doctor's colleagues and specialists. The column headers for the Consults screen are as follows:

(1) “Name”: name of the consultant with last name first;

(2) “Specialty”: the consultants specialty; and

(3) “Reason”: the doctor's reason for requesting the consult.

Clicking anywhere on the blank screen causes the following Consults Action Menu selections to pop up:

(1) “Add”: brings up a list of consultants from which the doctor selects to be added to a Consults list;

(2) “Delete”: allows the doctor to delete any consult that has been highlighted on the Consults list; and

(3) “Edit”: allows the doctor to edit any consult that has been highlighted on the Consults list.

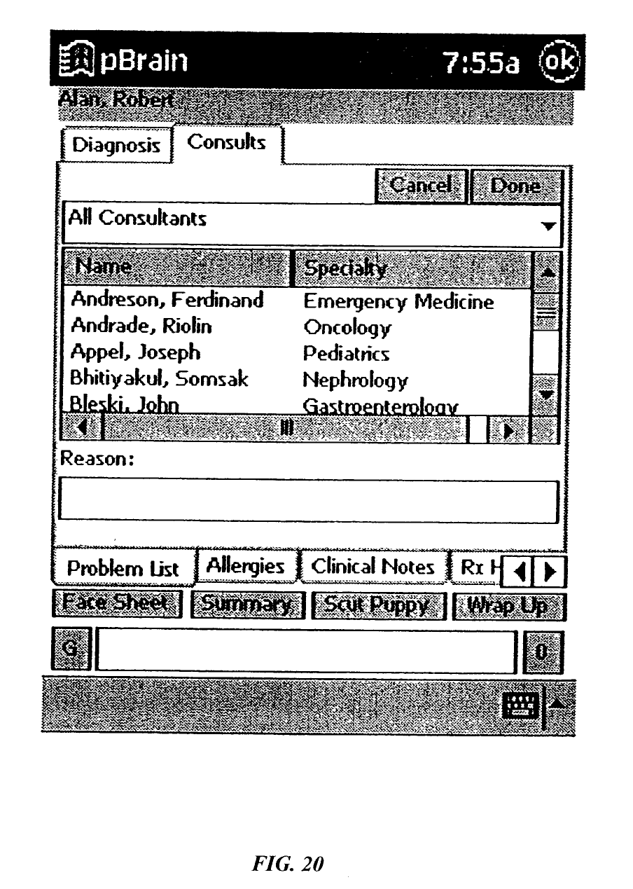

Selecting “Add” or “Edit” from the Consults Action Menu opens the Consult selection screen, as shown in FIG. 20. This window has column headings for sorting consultants by name and specialty. The names of the consultants can be quickly navigated by using the standard alphabetical keys located beneath the list or the scroll bar on the right-hand side of the screen. To select a consultant, the consultant's name is clicked on. Clicking directly on the name of a consultant causes a Special Order window to pop up. The Special Order window allows the doctor to make the following mutually exclusive urgency selections for a requested consultation:

(1) “STAT” (within a few hours);

(2) “Today” (before the close of business today);

(3) “24hTAT” (within the next 24 hours); and

(4) “Routine” (within the consultant's routine turn-around time).

Below the bottom of the list of consultants on the Consult selection window is a Reason box where the doctor must enter a reason for requesting the consult by using the keyboard or character recognizer. When the consultant is notified of the doctor's consultation requests, the consultant receives the Reason, along with the doctor's clinical note for the associated patient's visit.

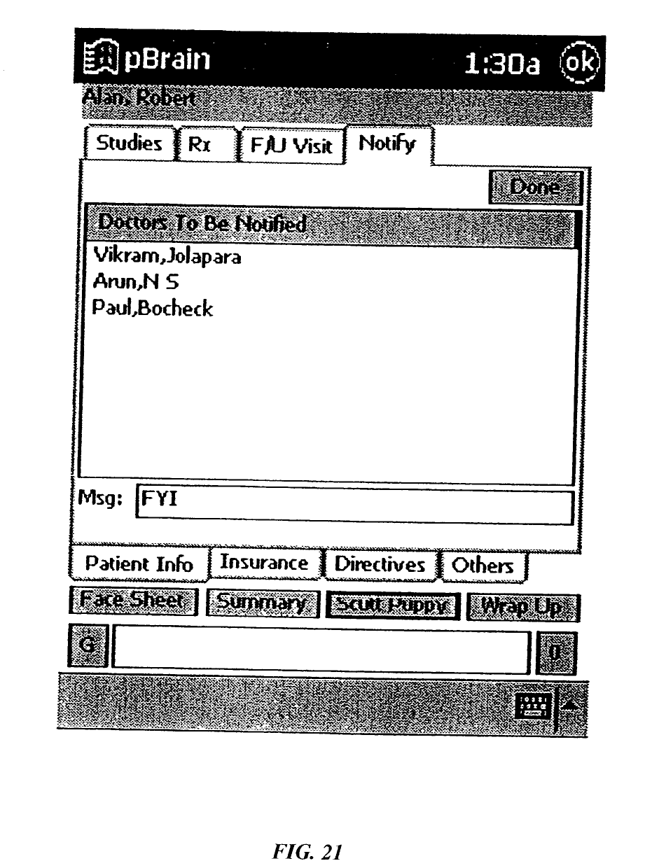

As shown in FIG. 21, a “Notify” screen presents an opportunity for the doctor to send a notification to any other entity selected from a list. This would most likely be other doctors, but could also be a hospital, the hospital's risk management coordinator, the doctor's clinical supervisor, the patient if the doctor wanted a copy of the patient's records, or even an HMO if the doctor's clinical note provides the necessary clinical information to get authorization for a procedure.

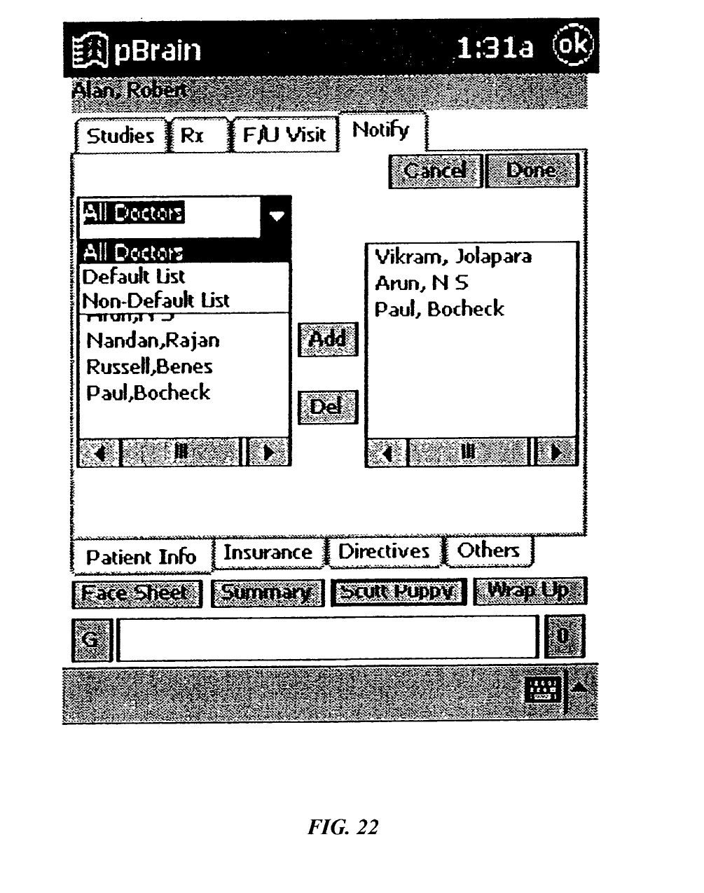

As shown in FIG. 22, the list of entities designated to receive a notification may be modified by adding, deleting, or assigning names of potential recipients of the notification to a default or non-default list. The notification may be sent to all doctors or to only those doctors placed on the default list.

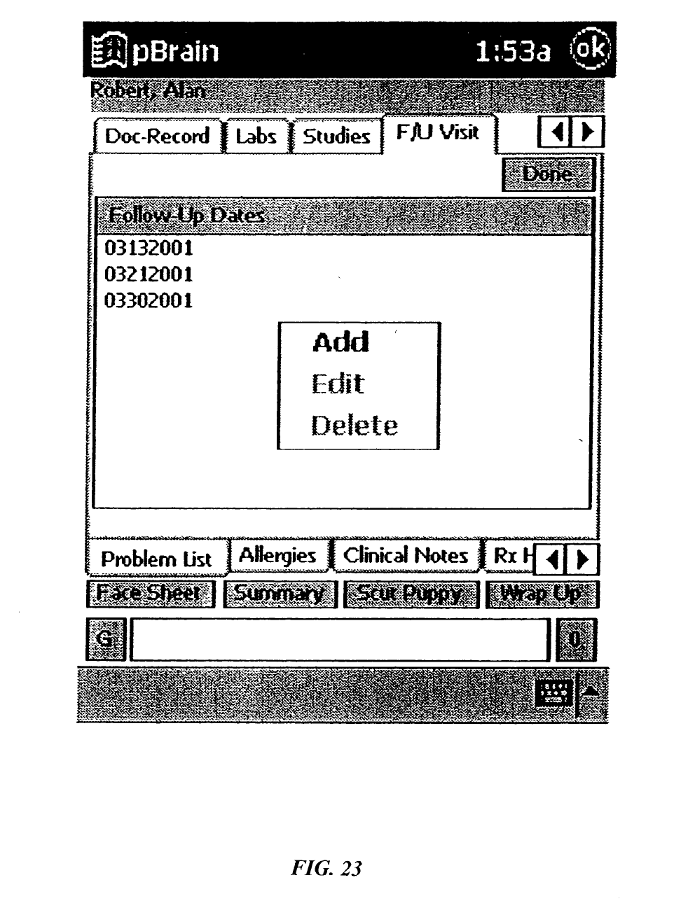

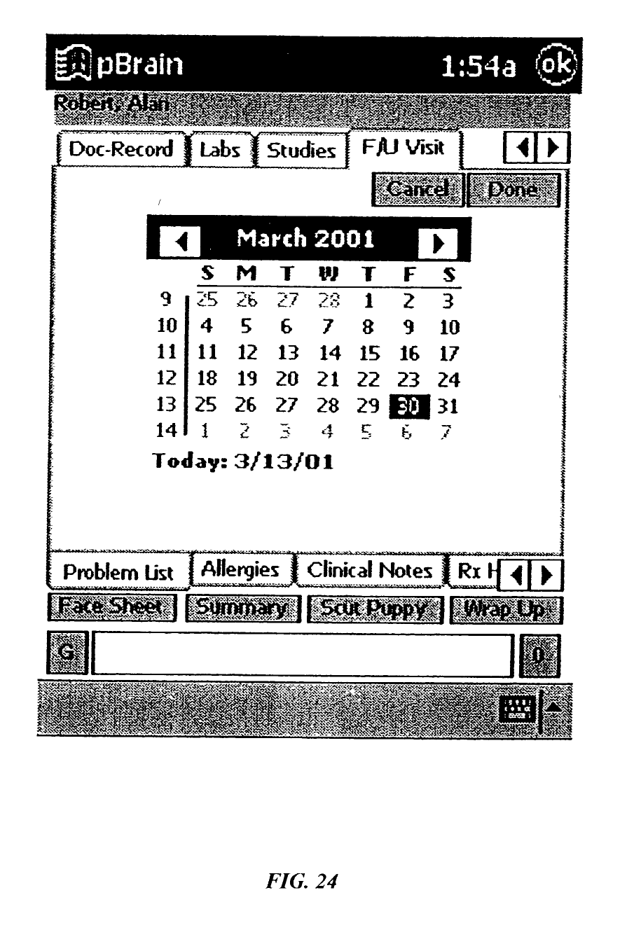

As shown in FIGS. 23 and 24, a Follow-up (F/U) Visit screen allows a doctor to select when the doctor's patient is to be scheduled for another visit. A Follow-up Visit action menu allows the doctor to select from a list of appointment day choices, and to modify or delete any previously scheduled appointments.

(4) Wrap Up

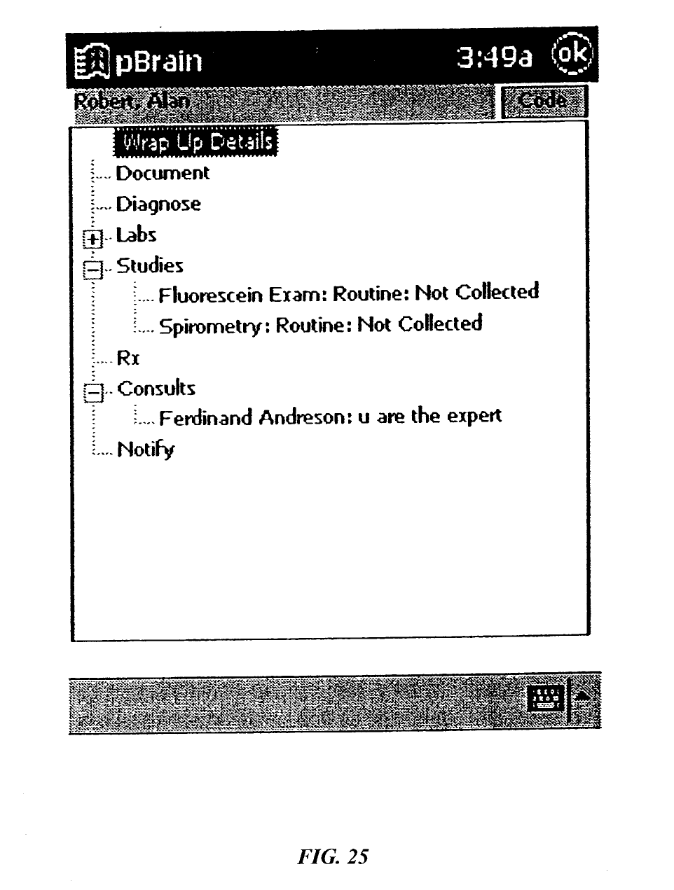

As shown in FIG. 25, a Wrap Up screen presents an overview of everything the doctor has done with a particular patient during the patient's visit. The Wrap Up screen is arranged in an expanding tree format, so that the doctor can check it for completeness and accuracy. If the doctor has forgotten something or desires to make a change for a particular item, the doctor need only click on that particular item and the display of the handheld device jumps to that screen. Alternatively, the Wrap-up screen may be exited by clicking on an OK key in the upper right-hand corner of the screen, which causes the handheld device's display to return to the Summary Record, where the doctor can continue working. After the doctor's work is completed, the doctor can return to the Wrap Up screen. When the doctor is satisfied that the visit has been completed, a “Code” button in the upper right-hand corner of the screen is clicked on to open a Code screen.

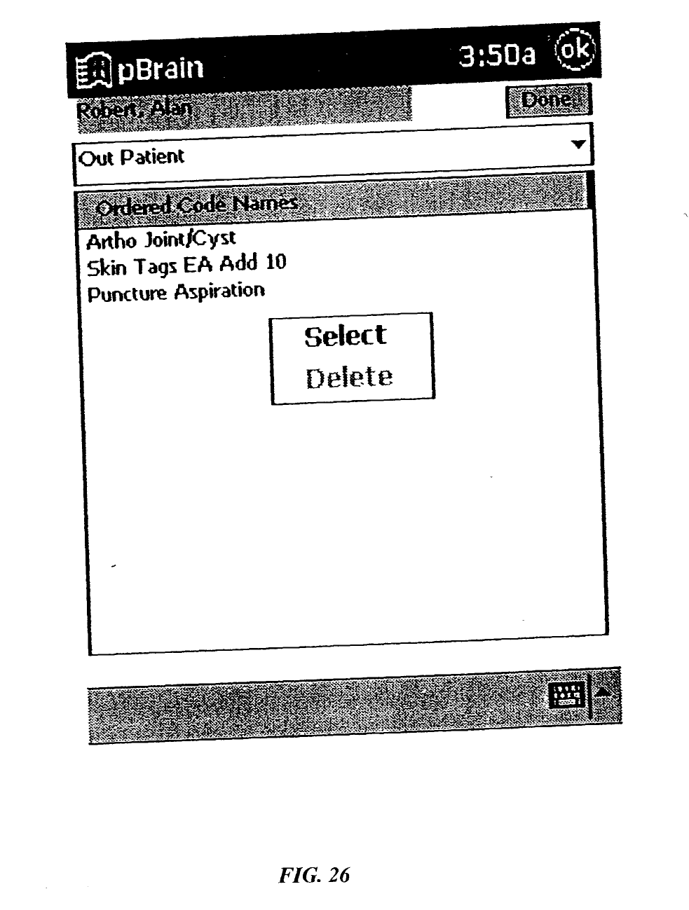

As shown in FIG. 26, the Code screen is where all CPT codes are captured to bill for a particular patient visit. The Code screen is functionally connected to other sections of the handheld device's display. For example, if the doctor ordered an EKG performed STAT in the doctor's office, the procedure code already appears on a Code list. If the doctor ordered a routine CBC and noted it as being collected, the procedure code for collecting the specimen appear on the Code list. All entries on the doctor's Code list can be modified by highlighting them, which pops up a menu that allows the doctor to select another code to add to the Code list, to edit the Code list, or to delete any code highlighted on the Code list.

(5) Tracking Functionality

Data related to lab test results, drug therapy, studies, diagnoses, signs and symptoms, and other medical related parameters may be tracked. This enables the longitudinal viewing of the data over time in a graphical format. More than one parameter may be viewed simultaneously. This tracking functionality allows the doctor to easily analyze the evolution of a patient's clinical condition over a period of time determined by the doctor.

(6) Handheld Device/Service Provider Integration

The handheld device is placed in communication with an Application Service Provider (ASP) for the healthcare industry that focuses on streamlining physician workflow by automating and reducing the time needed to complete clerical actions, clinical documentation and treatment plan execution.

By integrating advanced voice recognition with mobile and Internet technologies into a quick and easy point-of-care service, the ASP captures the doctor's clinical documentation on the handheld device, deciphers it into a medical record and treatment plan, executes the doctor's prescribed treatment plan, retrieves the results, and returns the results as instant messages displayed on the doctor's handheld device.

The ASP provides value to physicians in the following six key areas:

(1) Automation—automating point-of-care actions using voice recognition;

(2) Compliance—ensuring compliance with government regulations;

(3) Comparison—enabling comparative analysis of clinical data;

(4) Error Reduction—decreasing the probability of medical errors;

(5) Streamlining—reducing workflow inefficiency and cost; and

(6) Security and Privacy—locking up all sensitive data.

At the point of care, the physician enters the treatment plan and dictates the clinical note into his or her handheld device equipped with a touch-screen display, digital recording and wireless communication modules. That record is uploaded to the service provider, where it is deciphered using voice recognition and Natural Language Understanding technologies into the following six most frequently performed and time-consuming non-clinical actions:

(1) Creating and processing of electronic medical records (EMR);

(2) Coding of diagnoses and procedures;

(3) Generating insurance claims;

(4) Writing and transmitting prescriptions;

(5) Ordering and retrieving of laboratory and diagnostic tests; and

(6) Processing of consultation referrals.

Minimal additional commitment from the doctor or staff personnel is required. For real-time access to all services, the doctor can utilize a point and click interface found on the handheld device. Should the doctor choose to dictate his or her clinical notes, a one-hour turnaround is available for emergency requests, a two-hour turnaround for expedited requests, and a 24-hour turnaround for routine cases. Once approved, the service provider executes the tasks.

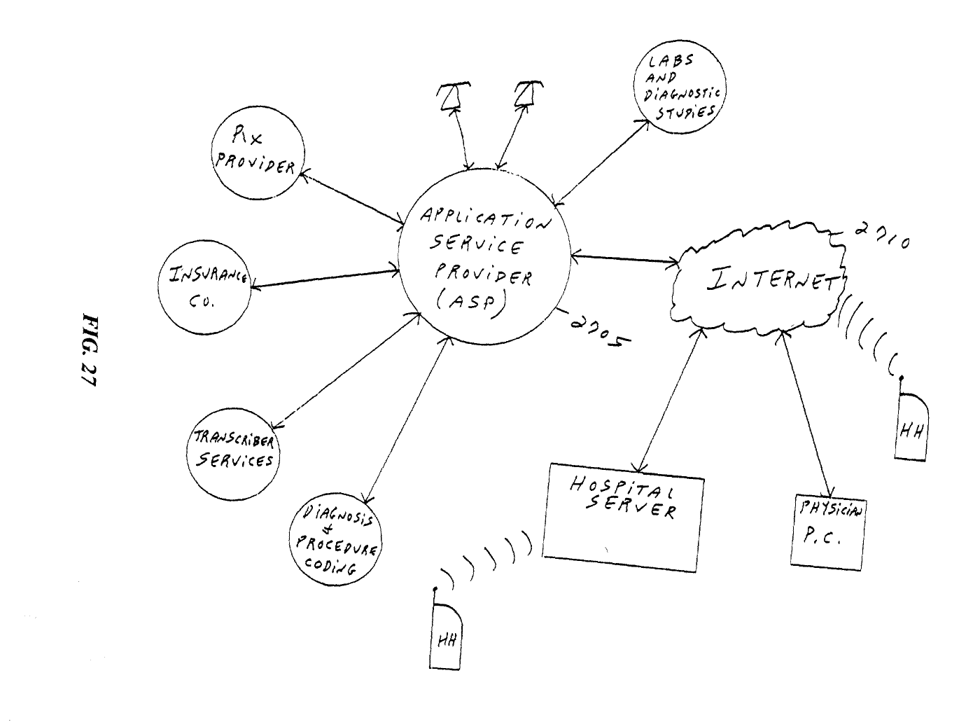

As shown in FIG. 27, an ASP 2705 is accessible from any location over wireless, conventional networks and the Internet 2710 using handhelds, PCs and telephones. Secure synchronization of WEB-resident data with the physician's PC and/or medical office site server is available. At the point-of-care, and during off-line operation, the physician is able to dictate clinical documentation, generate treatment plans, and digitally sign documents using a handheld device or PC. The new data is transferred over secure wireless or Internet connections to the ASP 2705 for processing, either automatically after office hours or on demand in the background while the doctor continues working.

Completed transcriptions, laboratory test results, diagnostic study results and participating physicians' consultation reports are encrypted and securely delivered to the medical office site server, physician PC or directly to the physician's handheld device as instant messages. The reviewed and electronically signed documents are then returned to the ASP 2705 for processing and automatic inclusion in the EMRs.

The ASP's Internet portal provides complete, secure and around-the clock access to all of the ASP's services, including emergency access to clinical summaries. Emergency medical synopses are available for downloading into the handheld devices. Physicians also are to use a standard secure web-browser to access their medical records online.

In a preferred embodiment of the present invention, a health care management system includes a central database and at least one portable user interface device. The central database stores a plurality of medical records associated with a plurality of patients. The portable user interface device stores a subset of the plurality of medical records in a memory in the portable user interface device, after which the portable user interface device allows a user to manage and track the status of health care activities for the patients associated with the subset of medical records independent of the central database.

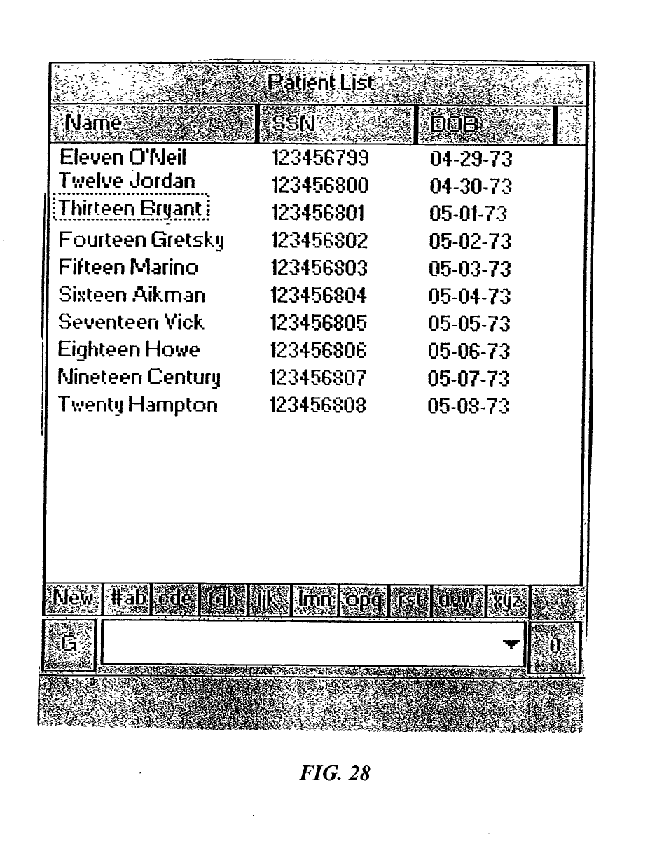

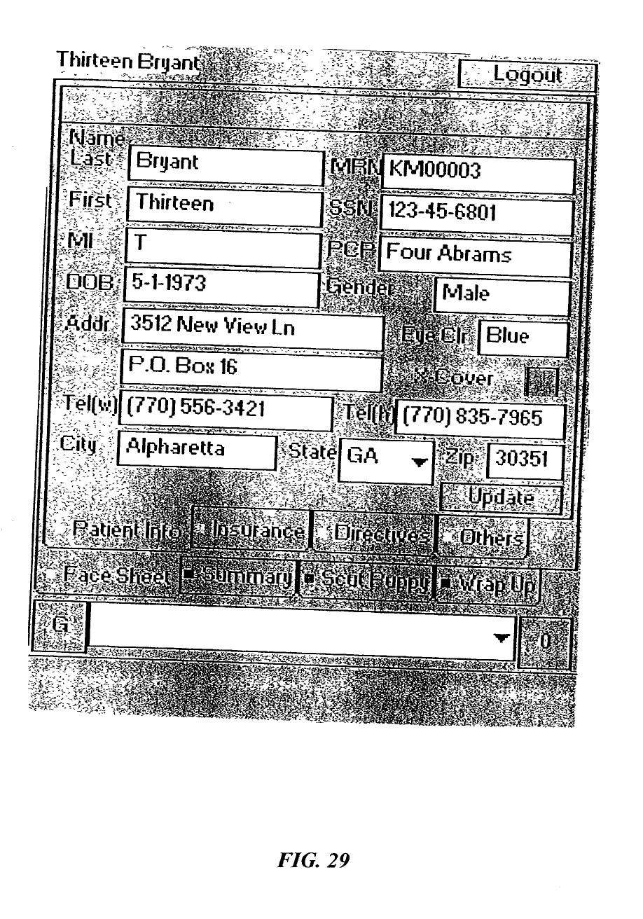

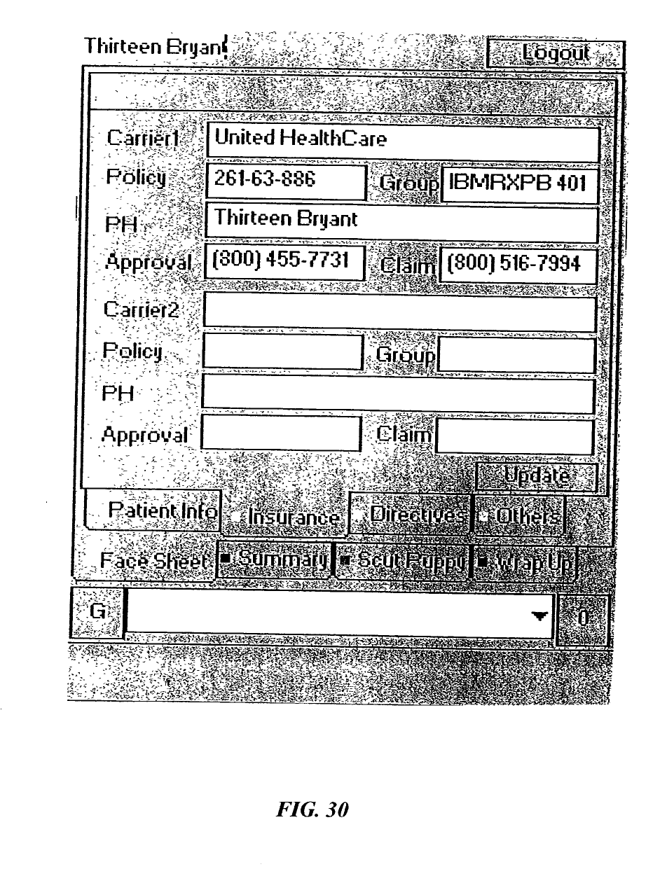

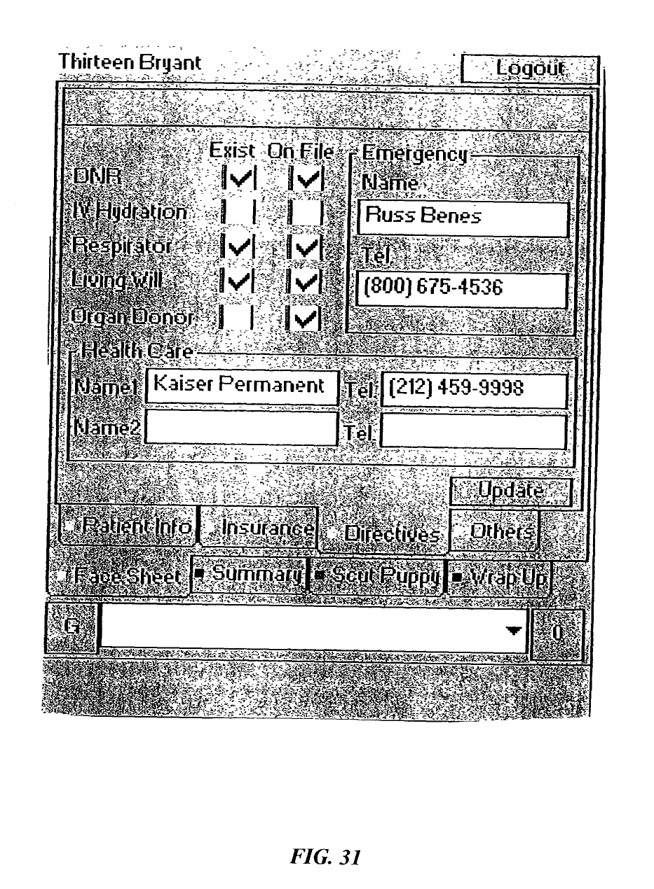

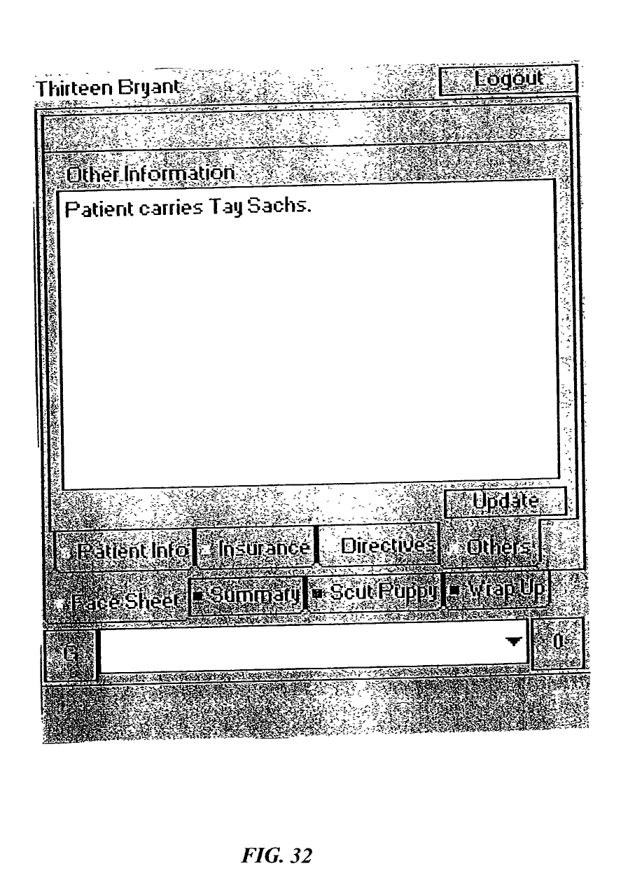

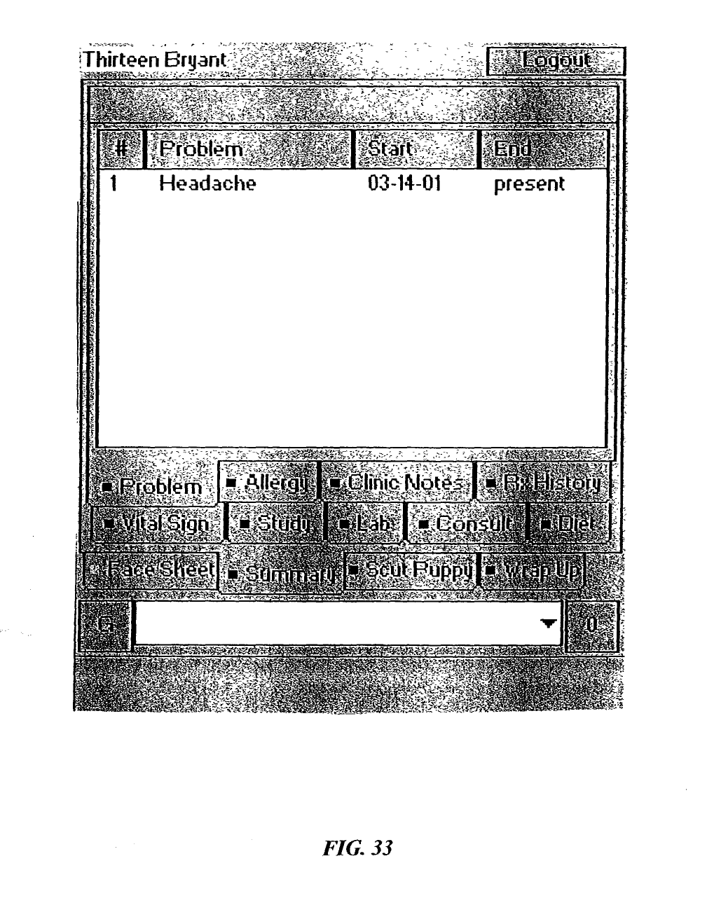

FIG. 28 shows a display of the portable user interface device on which a list is presented which identifies the patients associated with the subset of stored medical records. When one of the patients is selected from the list (e.g., “Thirteen Bryant”), the medical record associated with the selected patient is opened, as shown in FIG. 29. From this point forward, the user can enter, revise and review data regarding the selected patient's insurance (see FIG. 30), health cart directives (e.g., “Do Not Resuscitate”) (see FIG. 31) and other information, such as a disease that the patient carries (see FIG. 32). FIG. 33 shows a plurality of summary windows for documenting problems, allergies, inputting clinical notes, RX history, vital signs, study results, lab results, consult reports and dietary reports. The display on the portable user interface device presents a plurality of selectable windows including at least one activity initiation window for ordering health care activities associated with the selected patient (see “Order” windows shown in FIGS. 11-23) and an activity status window for presenting a list of the ordered health care activities and the status of each ordered health care activity (see “Wrap Up” window shown in FIG. 25).

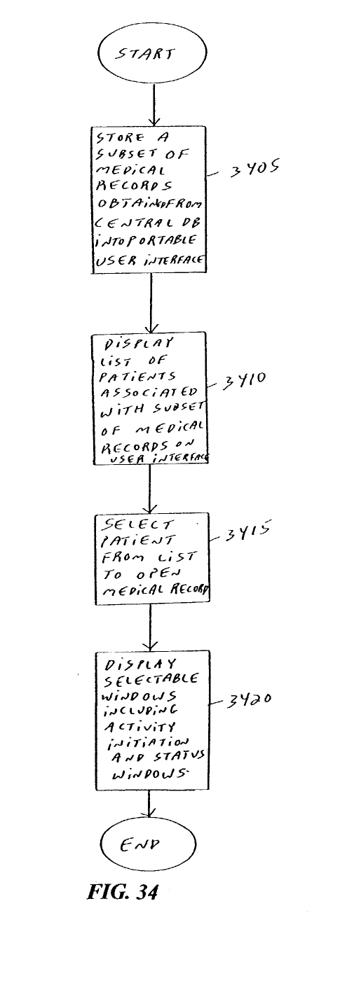

FIG. 34 is a flow chart which summarizes the preferred embodiment of the present invention. In step 3405, a subset of a plurality of centrally stored medical records is stored in the memory of a portable user interface device. In step 3410, a list of identified patients associated with the subset of medical records is displayed on a display residing on the portable user interface device. In step 3415, one of the medical records stored in the memory of the portable user interface device is opened by selecting a patient from the list of identified patients. In step 3420, a plurality of selectable windows are presented for display, including at least one activity initiation window and an activity status window as previously described.

(7) Medical Record Security and Privacy

The ASP's system security is an integral part of the service provided. The ASP utilizes web-hosting providers that supply multiple levels of physical, system and data security features. The doctor that creates particular data entries has control over who is authorized to review the data entries. Security features may be incorporated which require the authorization of the patient to release data from the patient's medical file to other entities, such as consultants, insurance companies, or the like. In some cases, confidential clinical notes may not be sent without a second confirmation of proper authorization by the doctor and/or patient.

(8) Fax/OCR

The handheld device is used to generate an order for the services of a health care study provider or consultant which can be printed from the handheld device or from an auxiliary printer. The printed copy of the order may be either physically sent via mail or courier, or it may be electronically transmitted via electronic means, such as facsimile or email. The order contains two parts, an identification (ID) sheet which is returned with a study report which includes the results of a health care study for correlation. The results of the health care study are then forwarded to an optical character recognition (OCR) system located in the ASP which reads text from paper facsimiles and extracts data from the ID sheet and the study report which are mapped to an originating order residing in the central database.

(9) Data Subset Synchronization

The present invention provides a handheld device which contains an application that allows a user (e.g., health care professional) to perform his or her daily health care routines, such as documenting patient visits by writing or recording comments on the handheld device. The user can also communicate with other service providers to request consultations and place orders for RX, Studies, Labs, Supplies, and Diets. In addition, the user can view EMR and all other pertinent patient data.

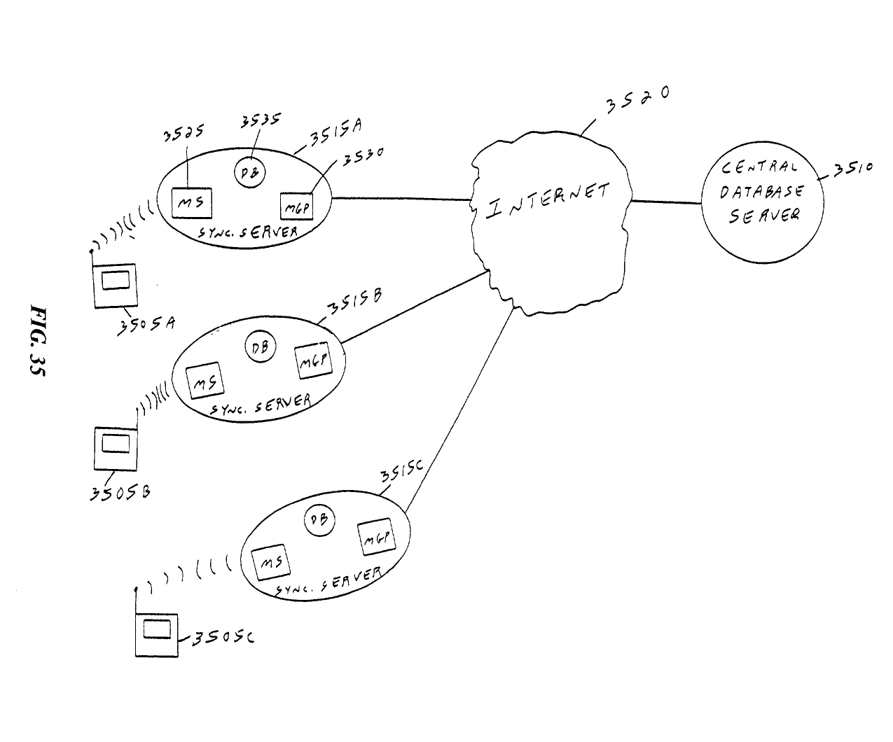

FIG. 35 shows one embodiment of the present invention, whereby a health care management system 3500 allows users of a plurality of portable user interface devices 3505A, 3505B, 3505C to manage the health care of a plurality of patients. The health care management system 3500 includes a central database server 3510 which communicates with a plurality of synchronization servers 3515A, 3515B, 3515C via the Internet 3520. The central database server 3510 stores a complete collection of health care data (e.g., medical records). The central database server 3510 may be implemented as an Oracle 9i EE database running on an AIX server. The synchronization servers 3515A, 3515B, 3515C are used to directly refresh data used by the portable handheld devices 3505A, 3505B, 3505C to manage health care. The synchronization servers 3515A, 3515B, 3515C may be physically implemented as an Oracle 9i EE database running a Windows 2000 advanced server. Each synchronization server 3515 includes a mobile server 3525, a message generator/processor (MGP) 3530 and a synchronization database 3535, which may be an Oracle 9iLite database. Each of the synchronization databases 3535 store a respective subset (by-practitioner slice) of the data residing in the central database server 3510. The mobile server 3525 may be an Oracle supplied, web based 9iLite component used to administer and define the propagation of data to 9iLite databases. The MGP 3530 may be an Oracle supplied J2EE 9iLite component which keeps track of the state of each 9iLite database (in the portable user interface devices) and propagates changes from synchronization server 3515 to the portable user interface devices 3505A, 3505B, 3505C. Tables in the central database server 3510 contain data which flow to the respective synchronization servers 3515A, 3515B, 3515C. The rate at which the memories of the portable user interface devices 3505A, 3505B, 3505C are refreshed with data received from the central database server 3510 may be specified on an individual basis. Data updates are propagated up to the central database server 3510 from the portable user interface devices 3505A, 3505B, 3505C and vice versa during a synchronization cycle, insuring data integrity between the central database server 3510 and the portable user interface devices 3505A, 3505B, 3505C. Each of the portable user interface devices 3505A, 3505B, 3505C contain two 9iLite repositories (not shown), one for performing as a main database for storing core data and a second smaller database for storing the 9iLite “state information”. Alternatively, the synchronization servers 3515A, 3515B, 3515C may be incorporated within the central database server 3510 or placed directly in communication therewith.

(10) Transcription Services

The ASP combines large vocabulary voice recognition (IBM's Via Voice) and Natural Language Understanding technologies to achieve high accuracy of speech-to-text transcription (up to 98%) of the doctor's dictation as it is received from the handheld device. To further enhance the accuracy of the transcription, qualified medical professionals proofread the automated transcription. The distinguishing feature of the voice engine is the absence of any time-consuming and frustrating speaker-dependent training, which is typically needed in a standard desktop-based voice recognition environment. As the system learns the voice footprint and actions of the user, and as voice recognition technology advances, the need for proofreading by qualified medical professionals gradually decreases.

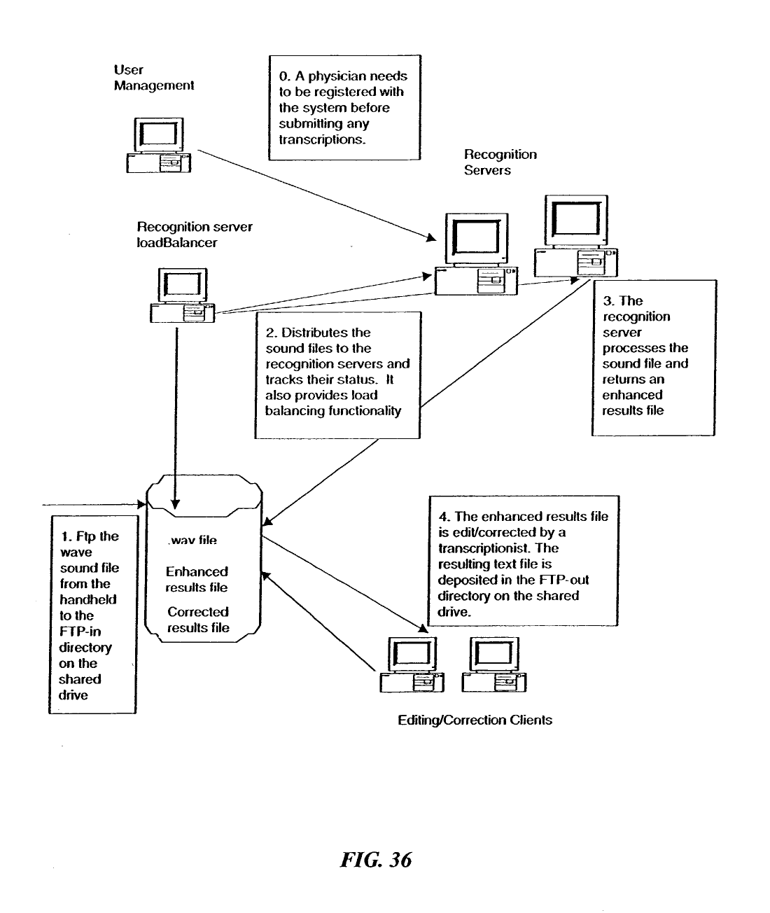

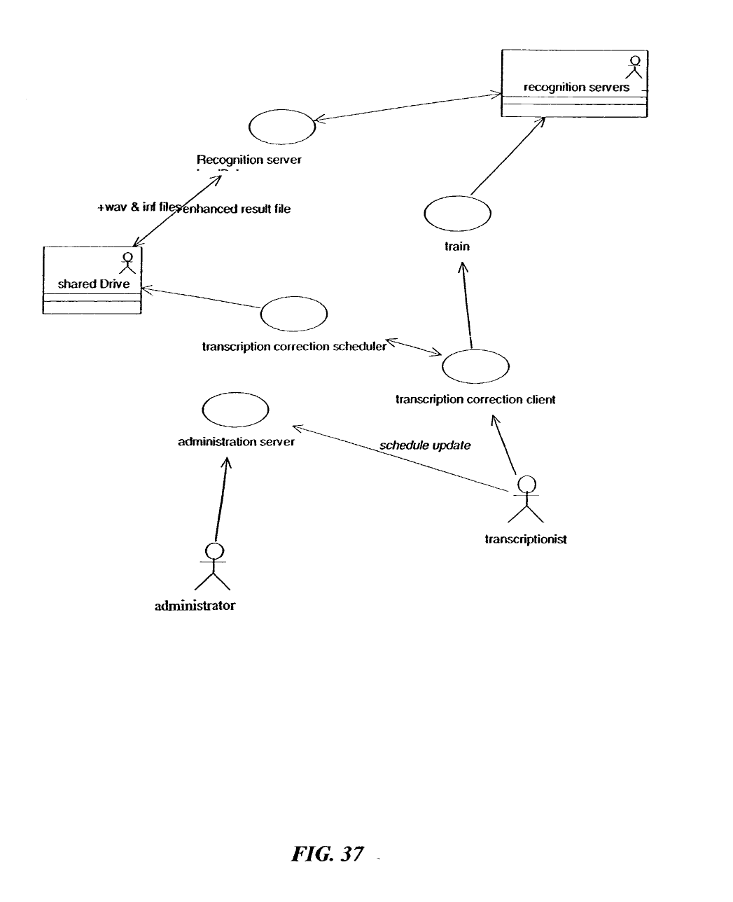

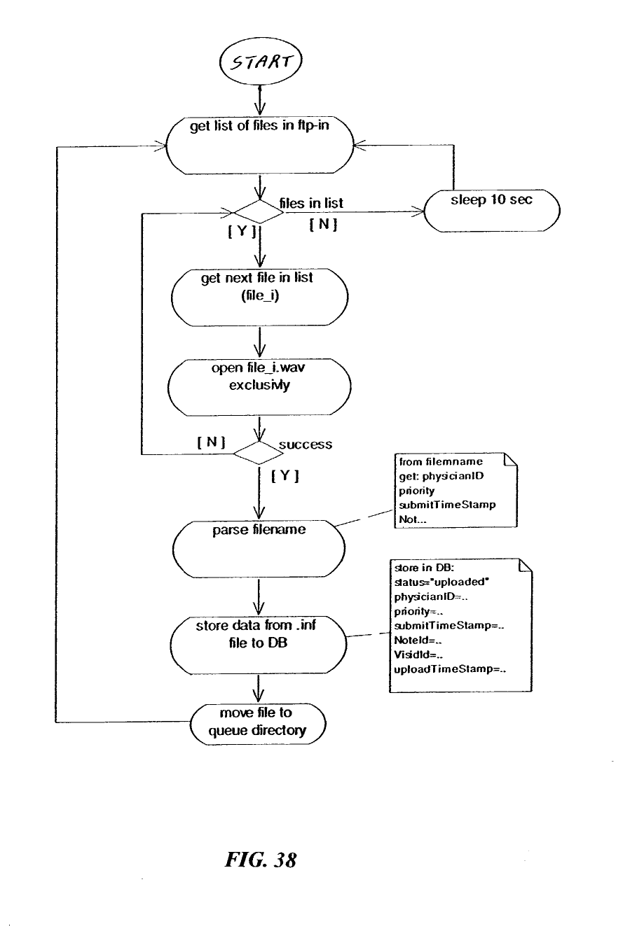

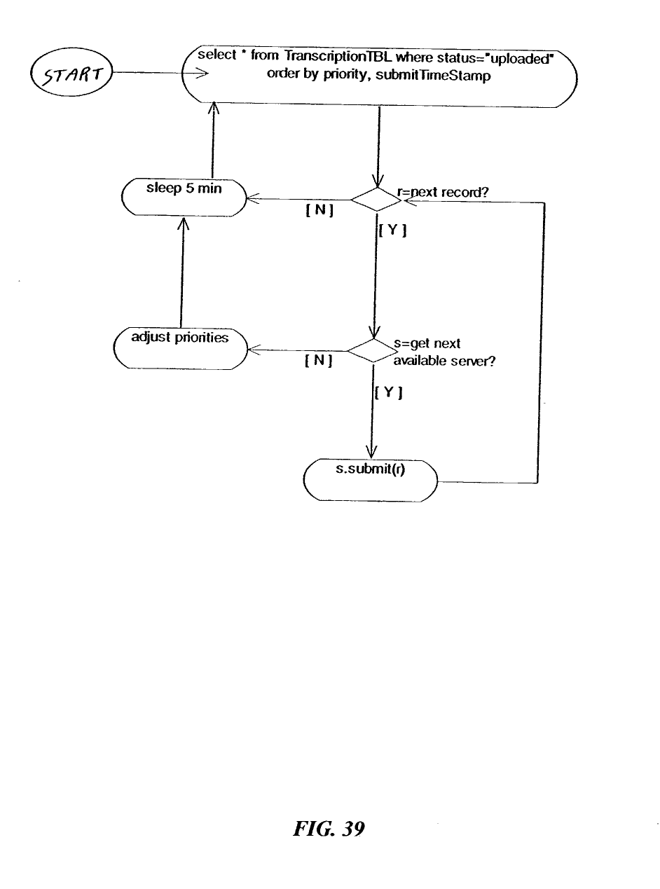

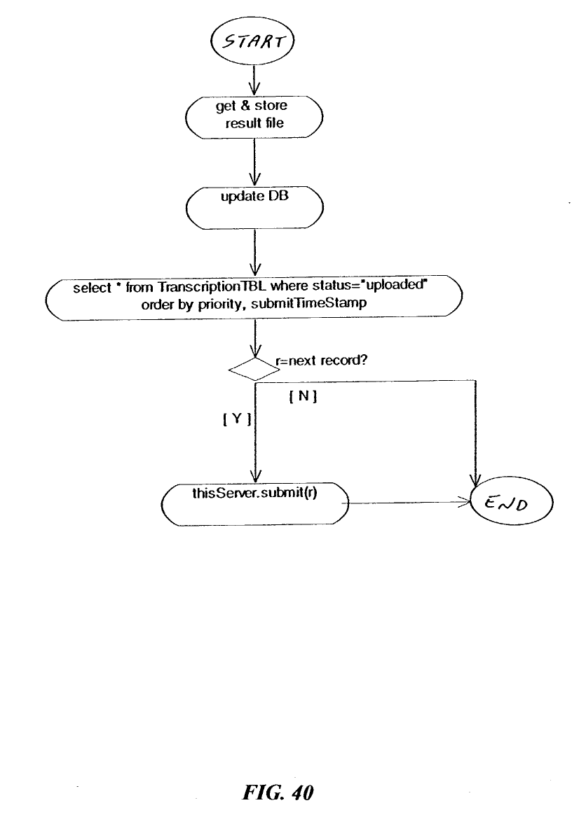

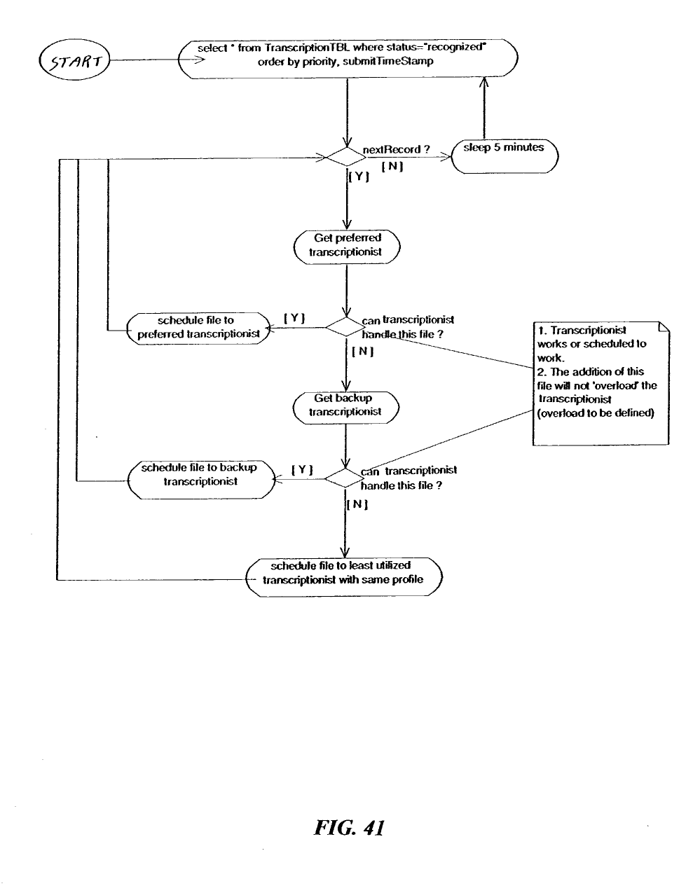

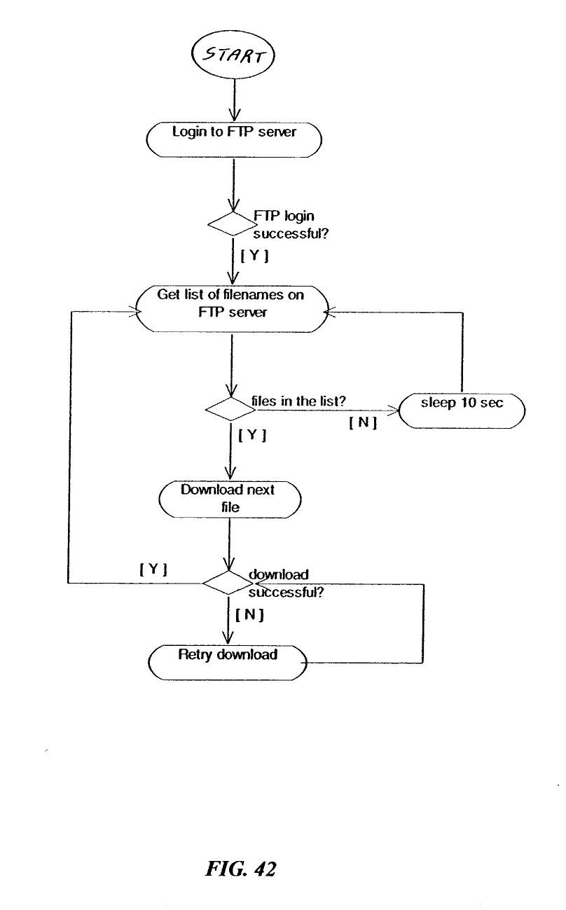

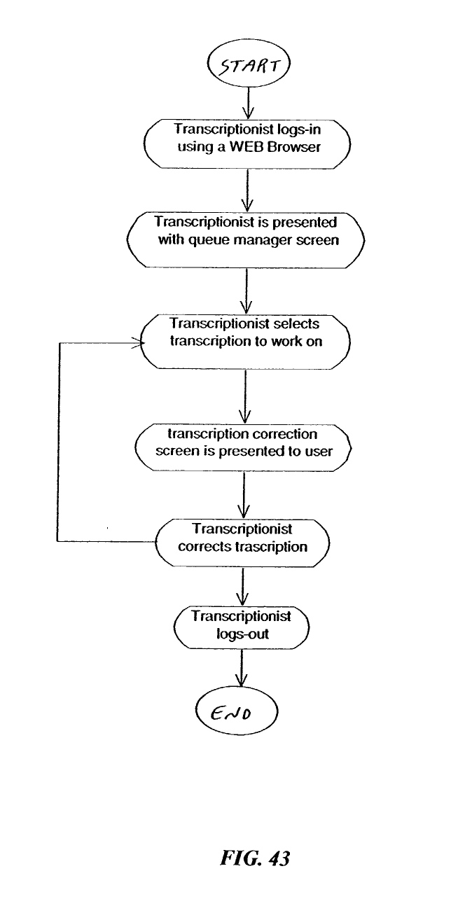

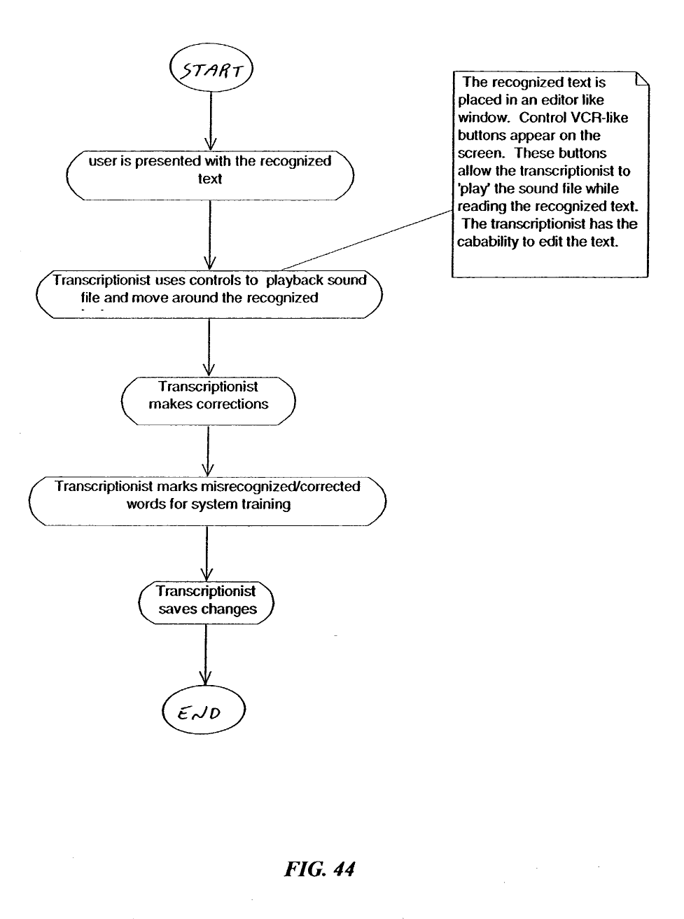

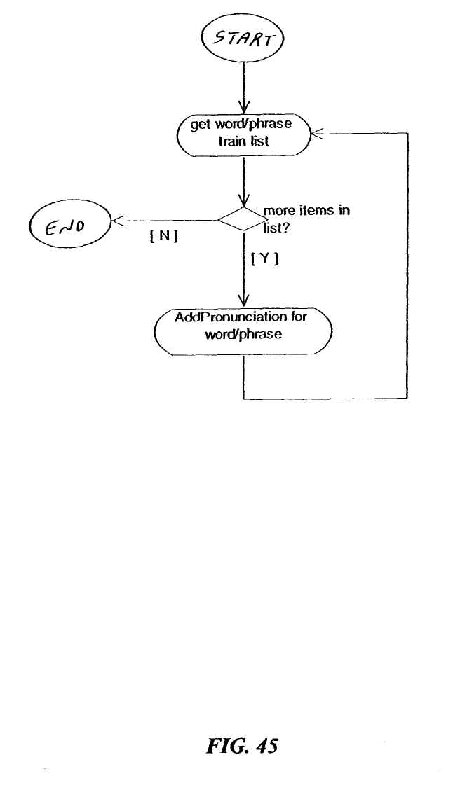

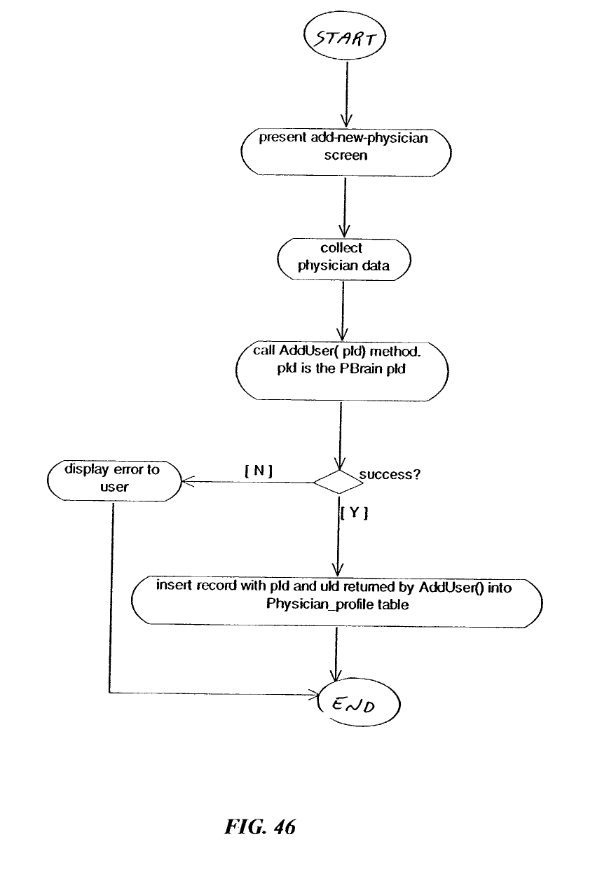

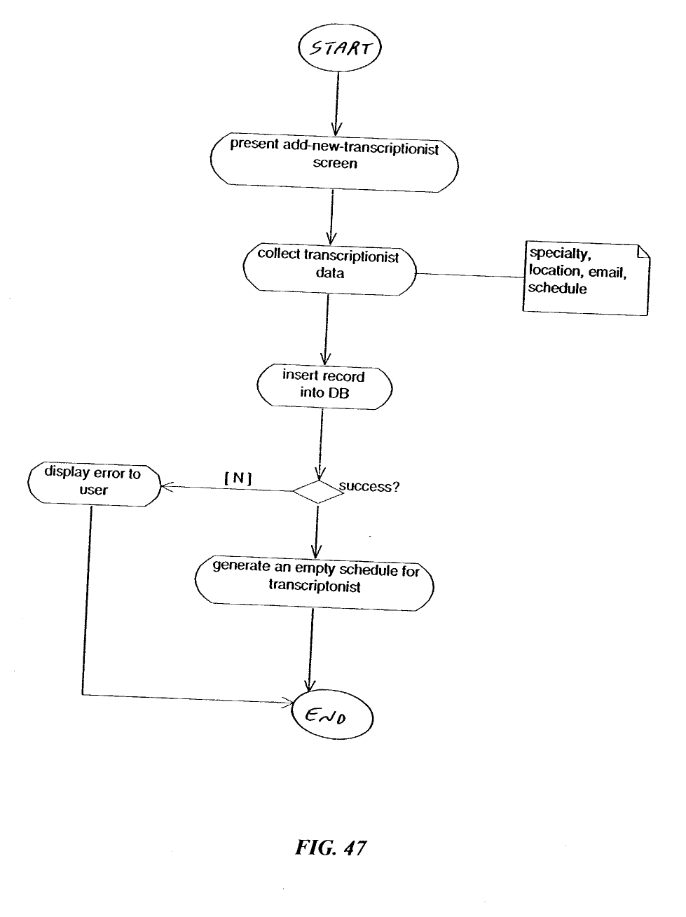

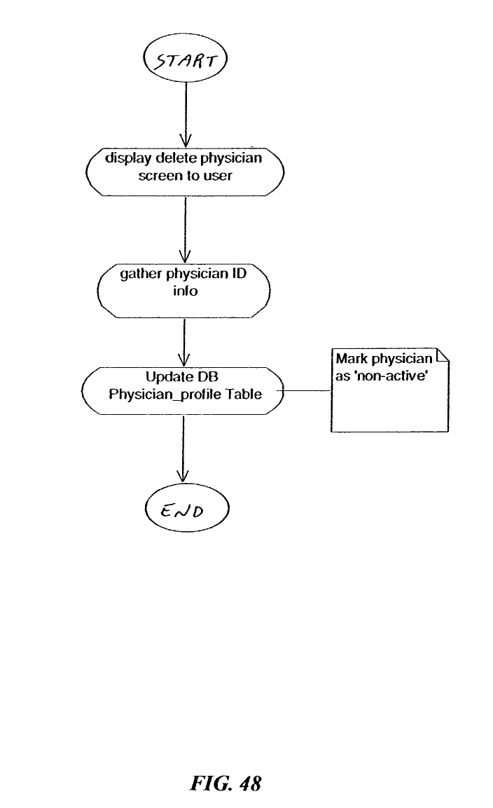

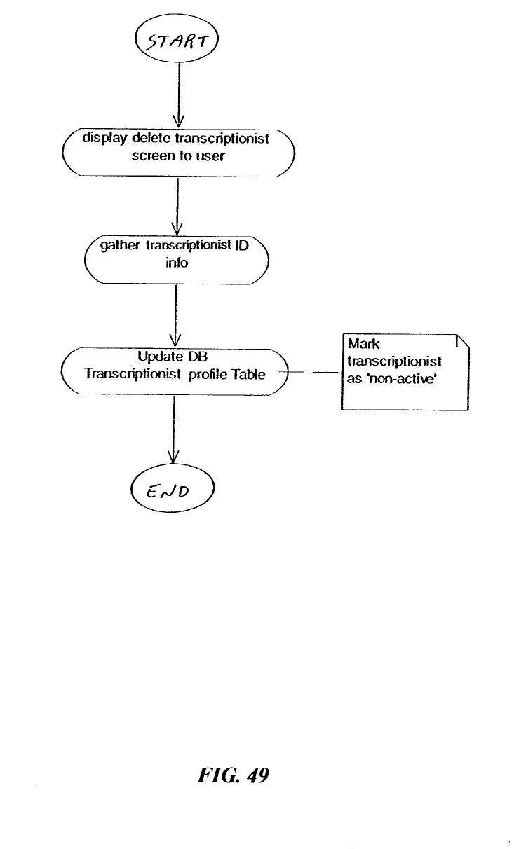

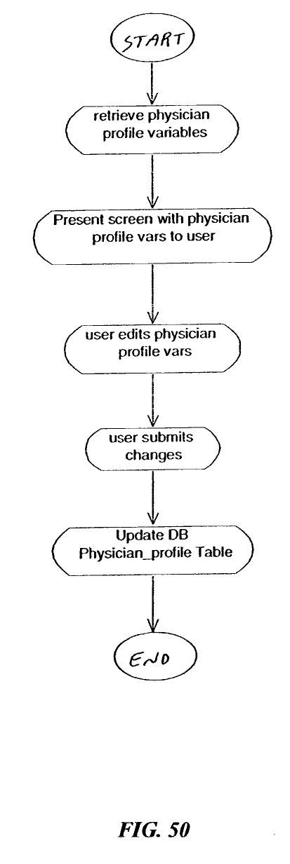

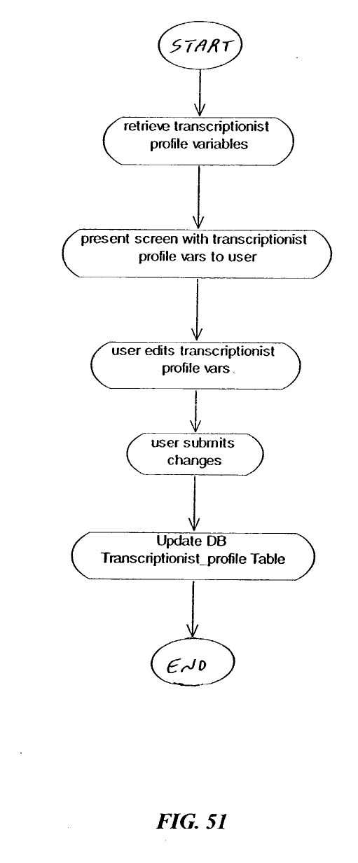

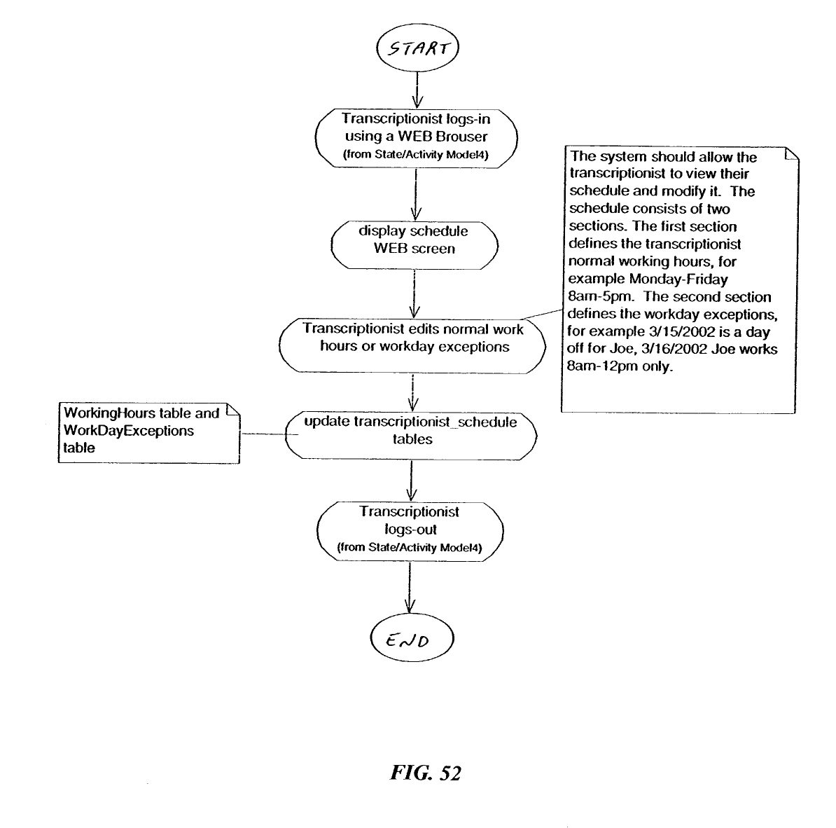

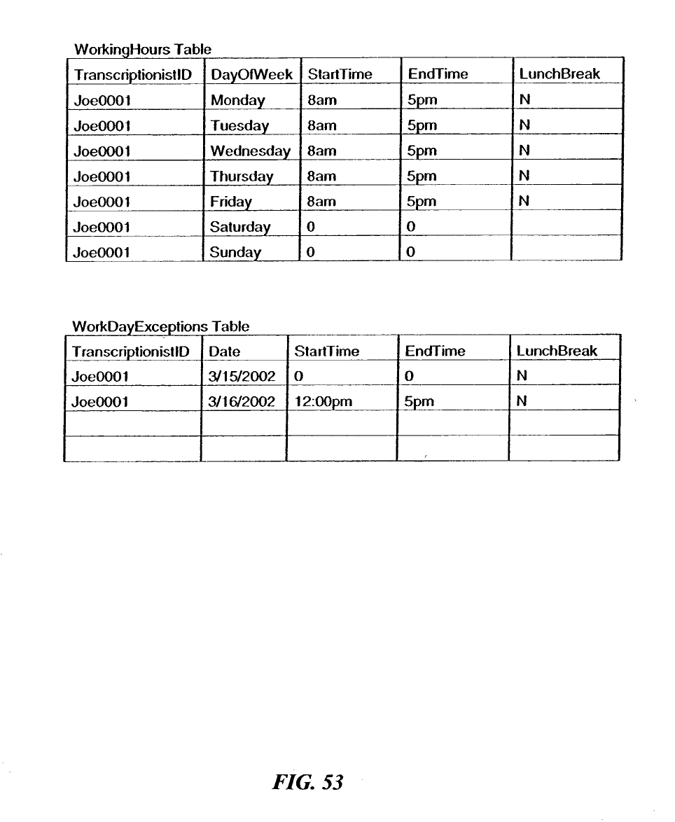

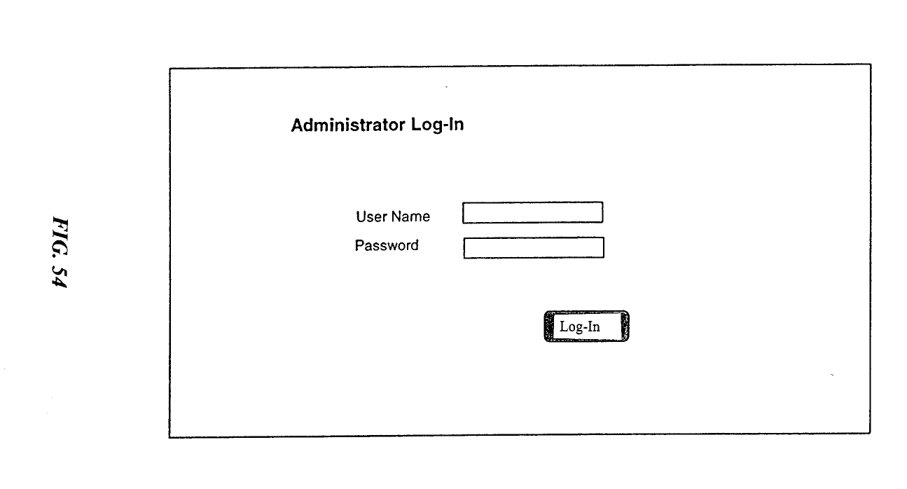

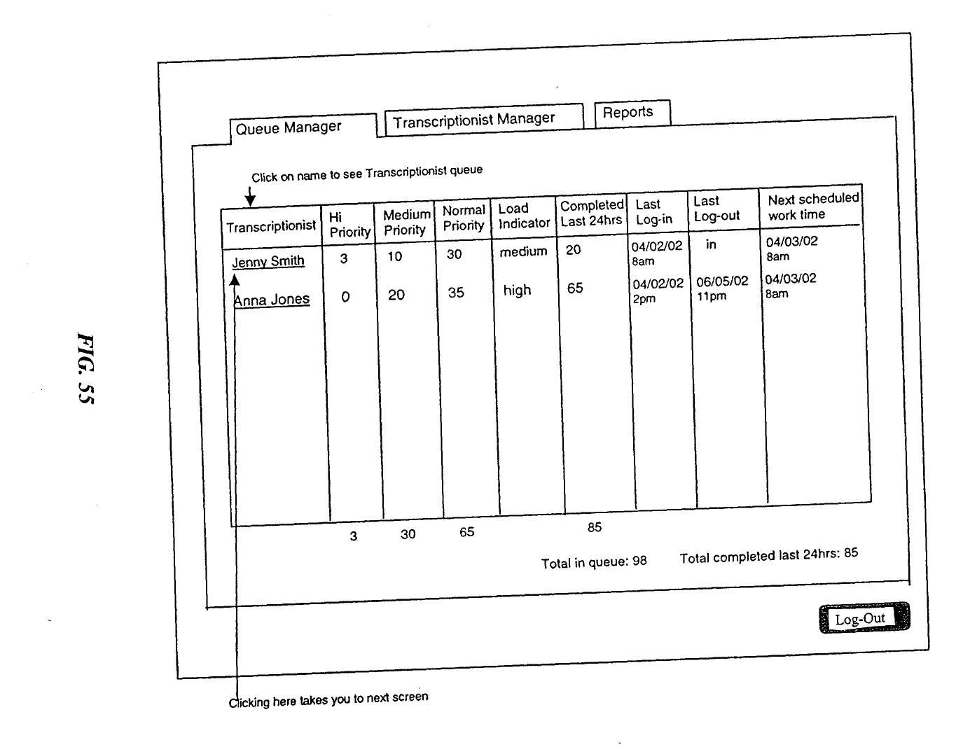

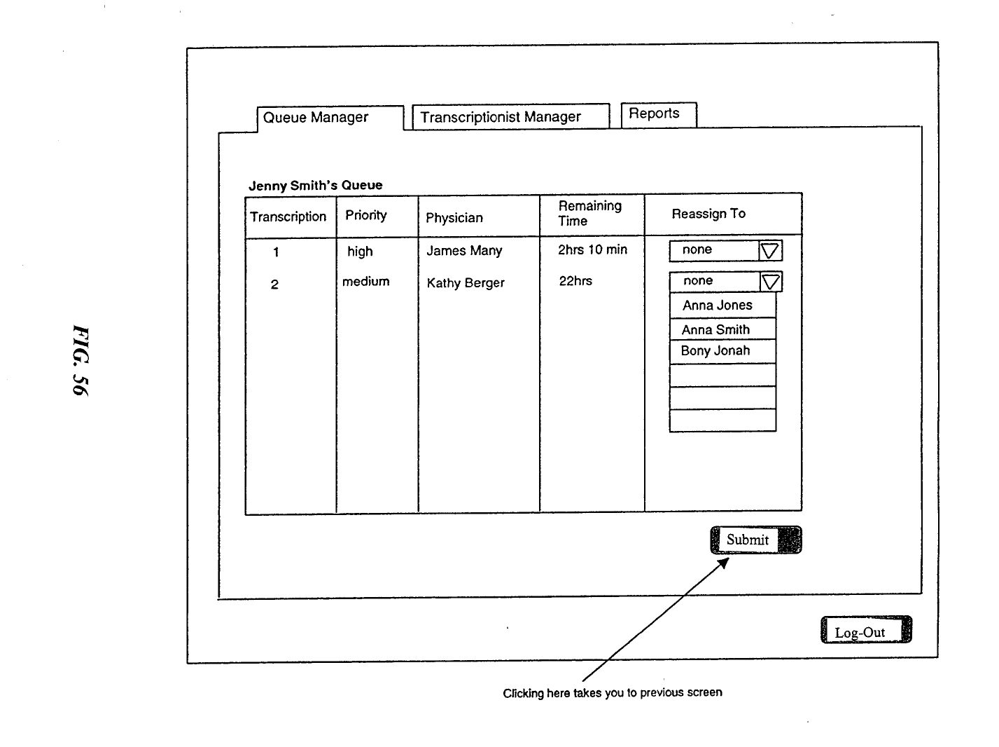

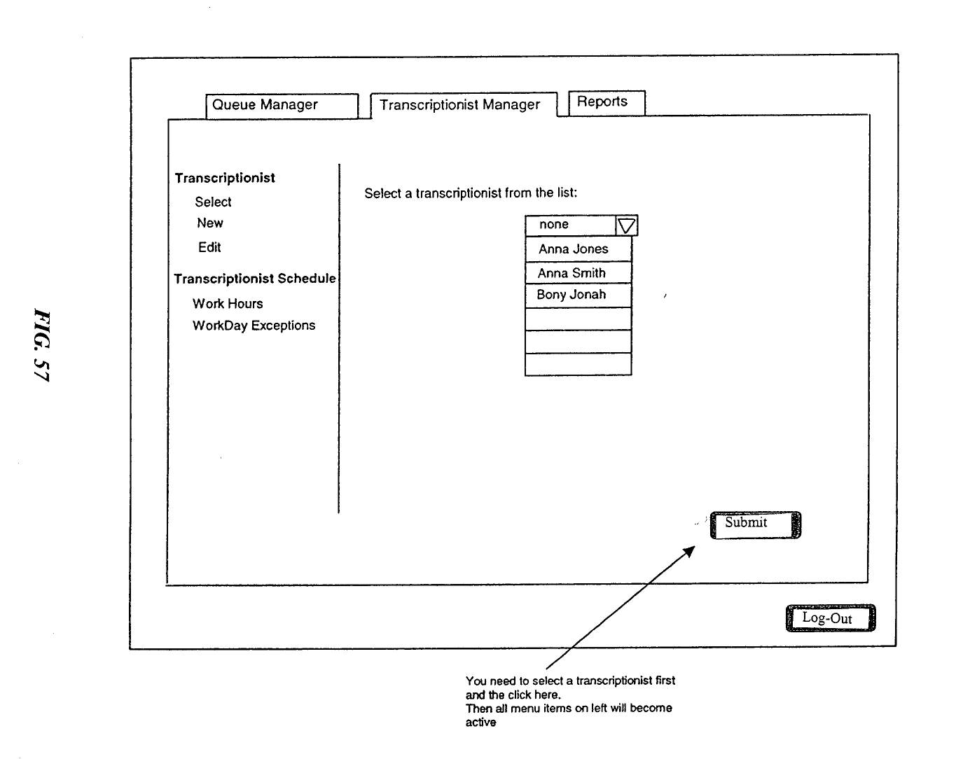

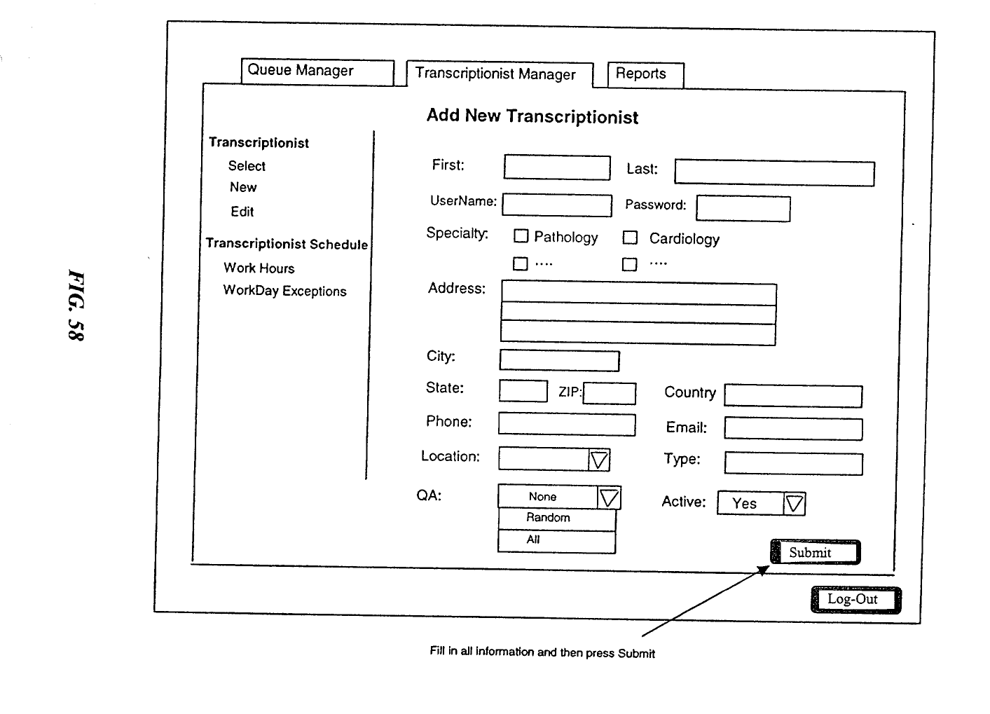

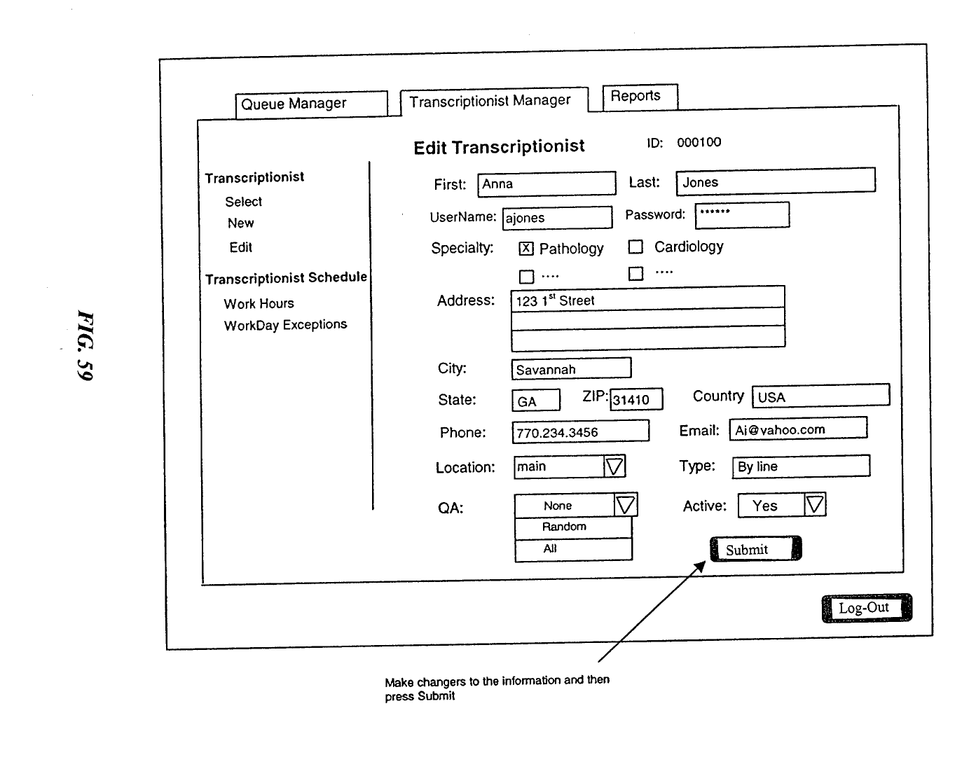

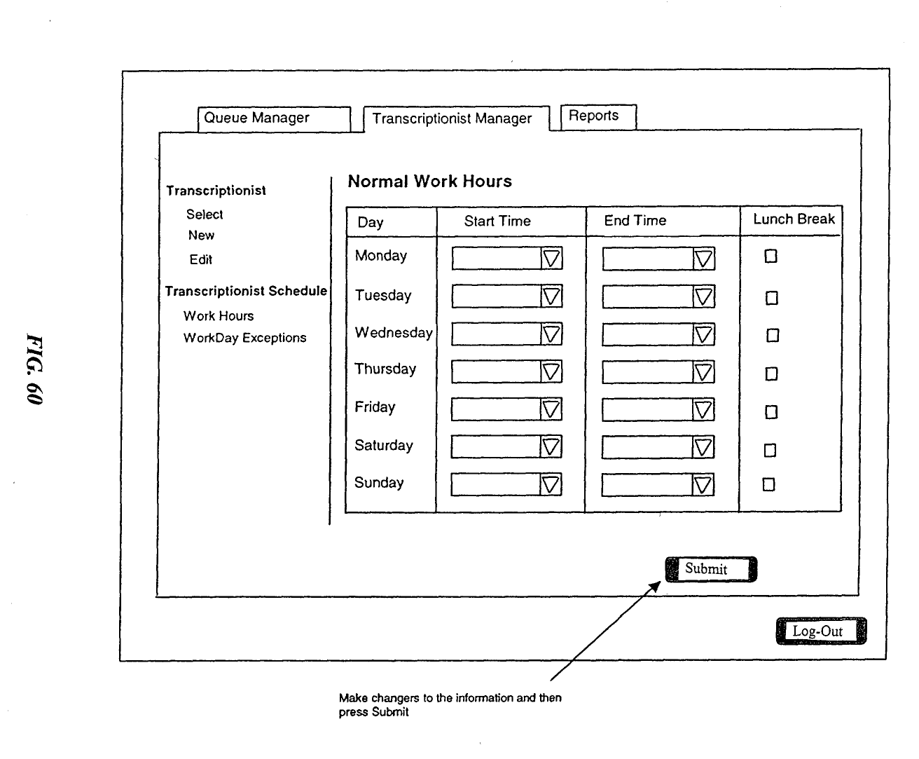

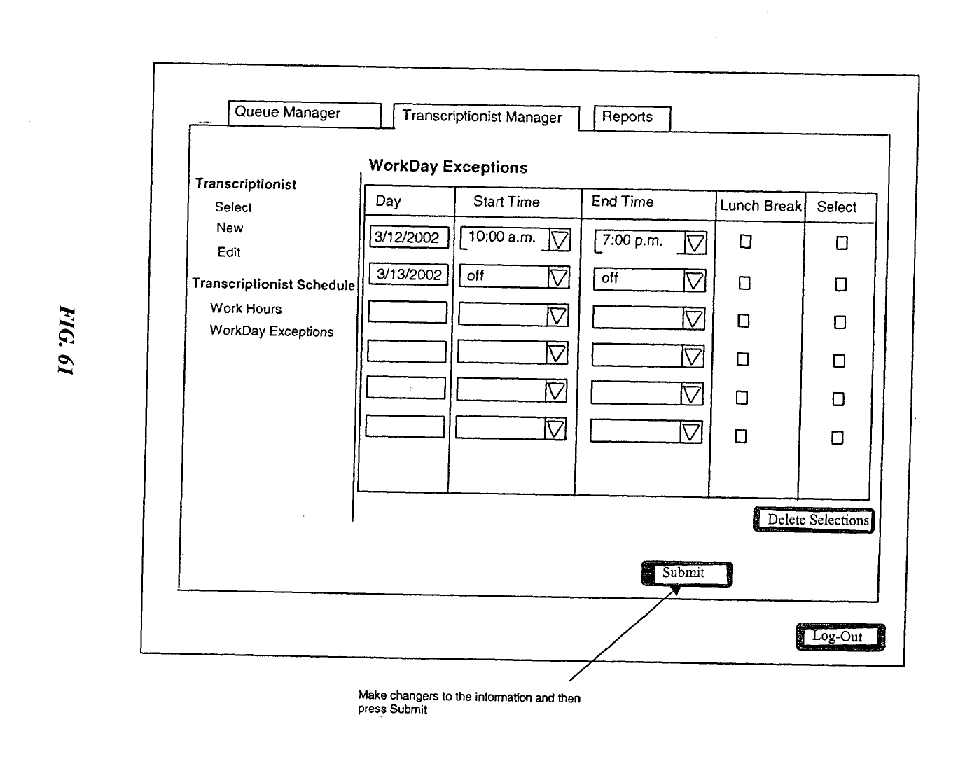

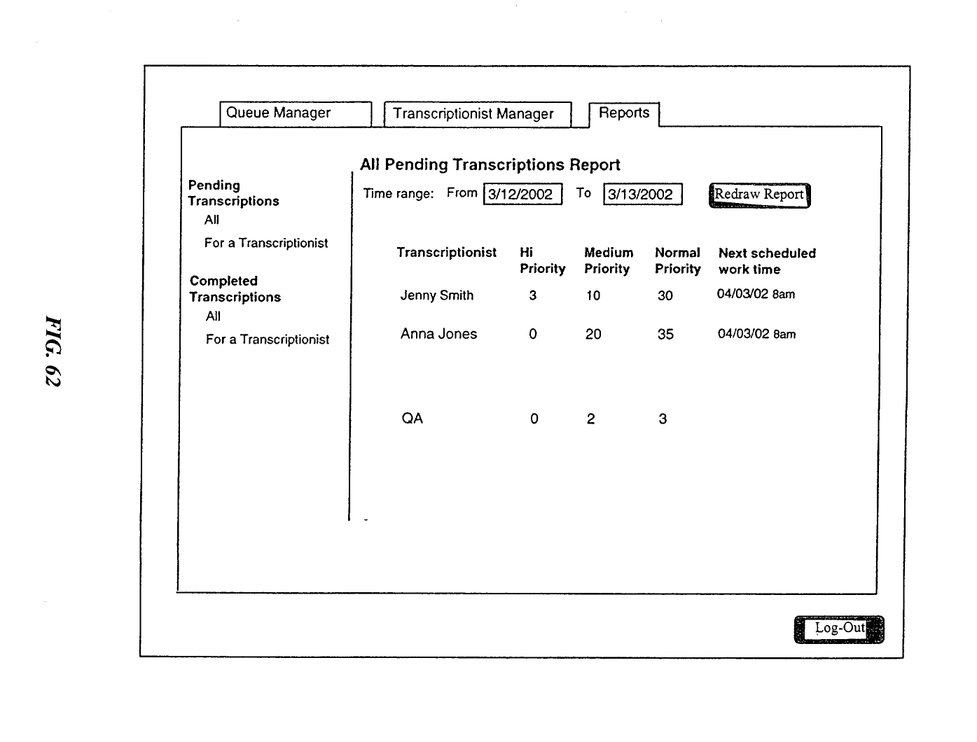

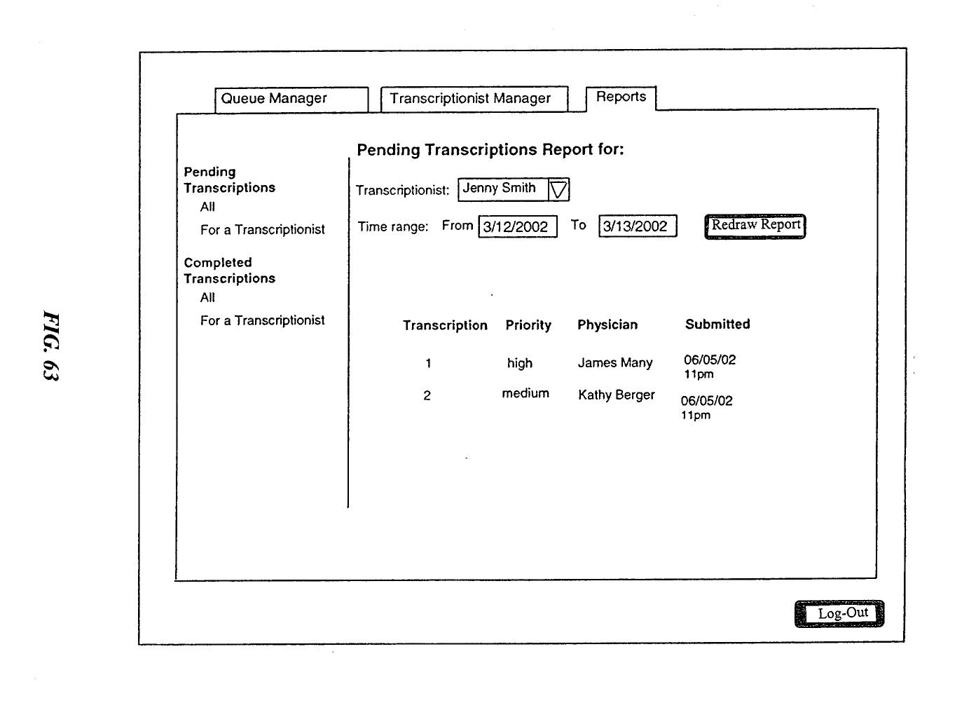

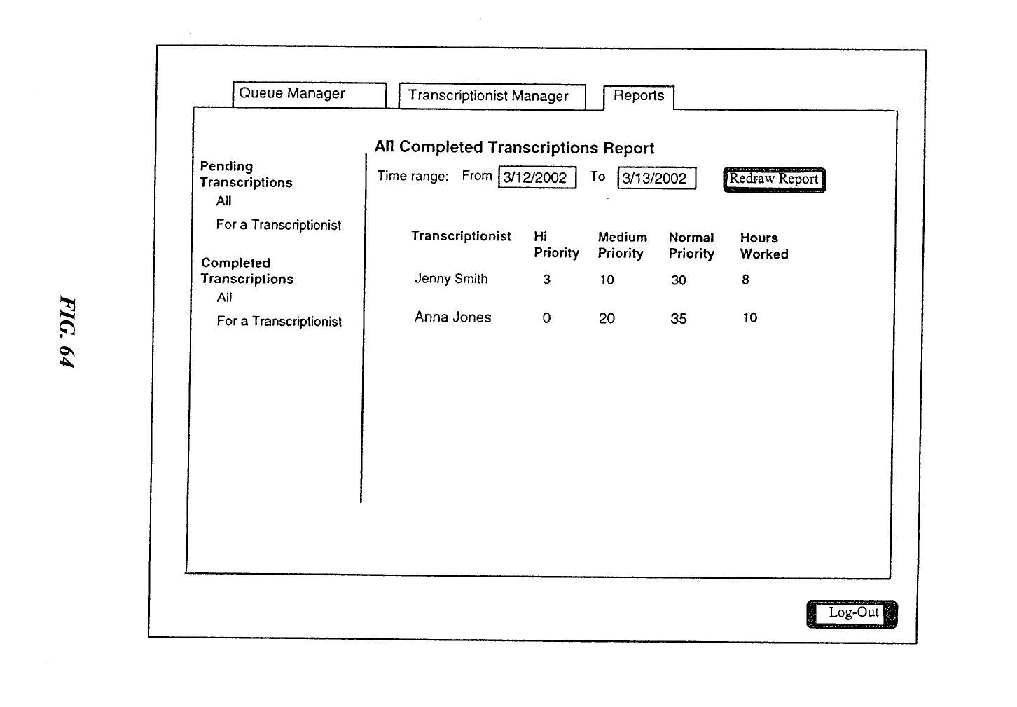

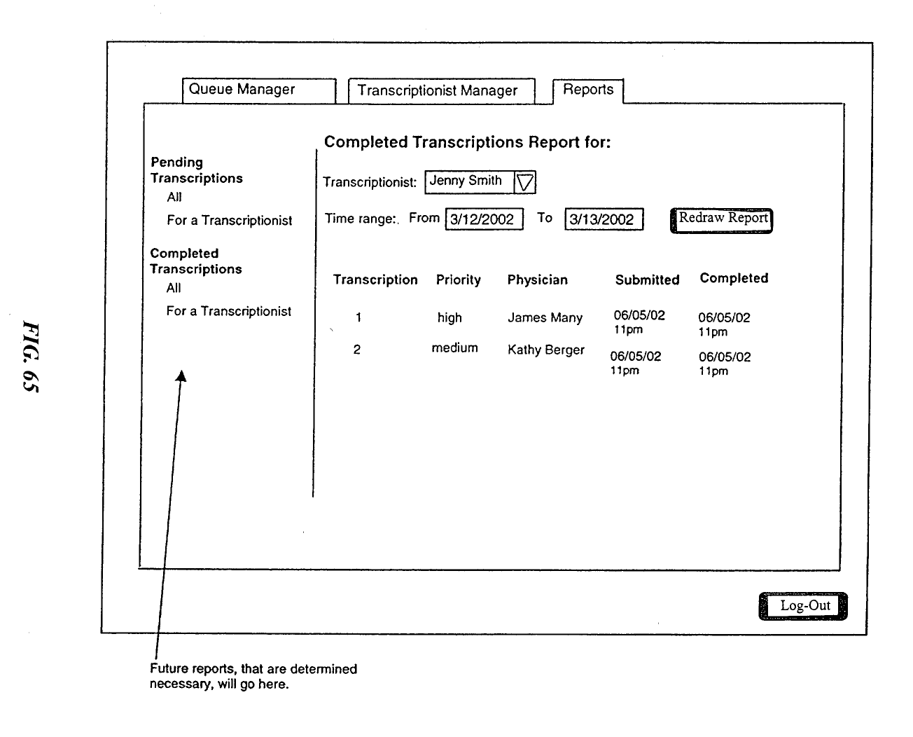

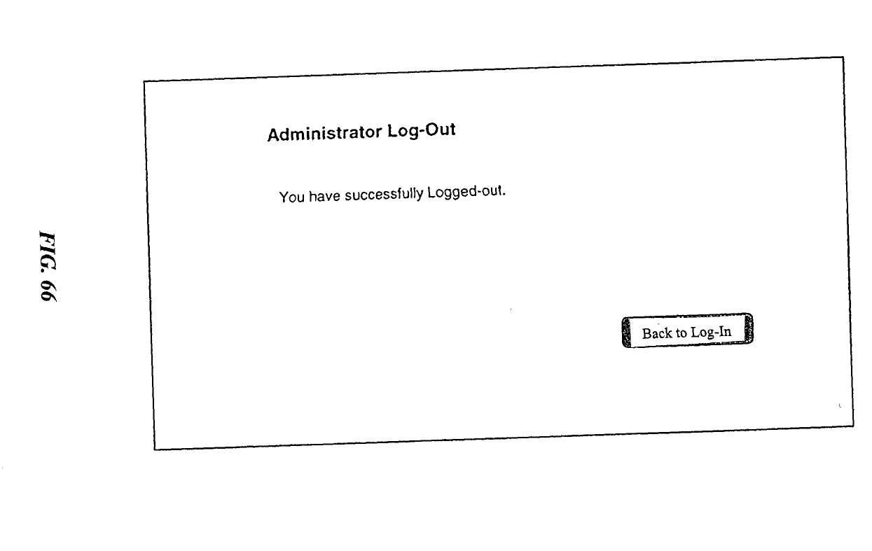

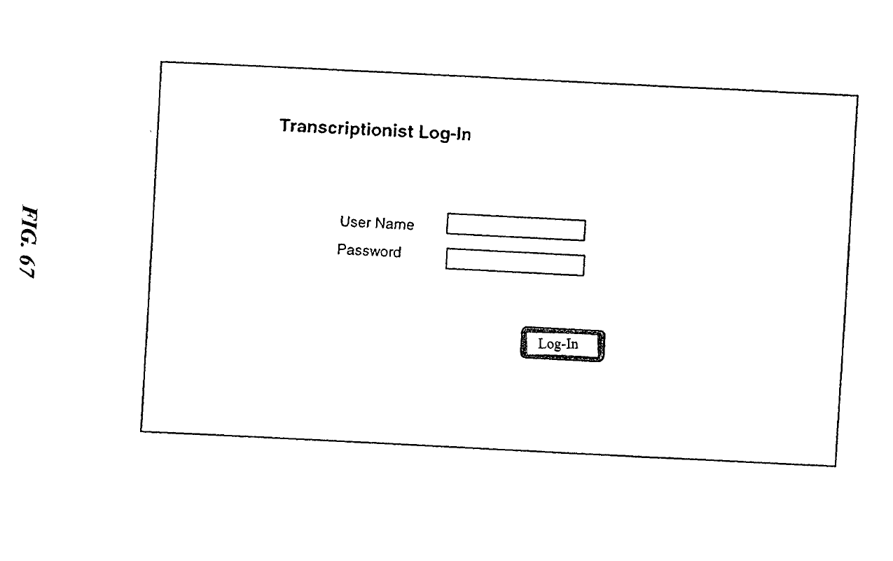

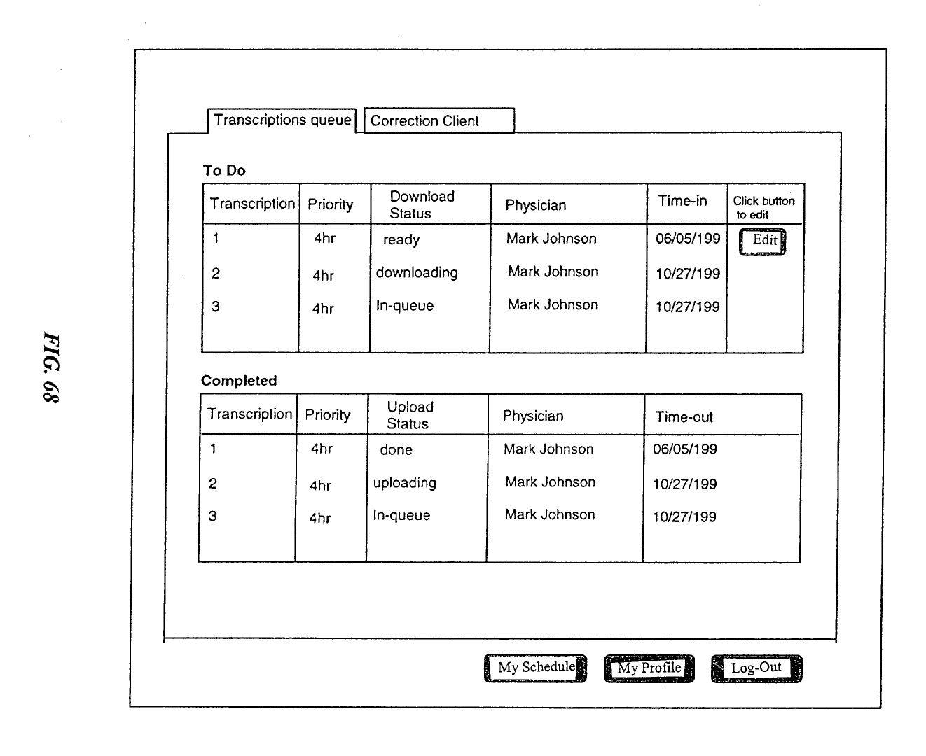

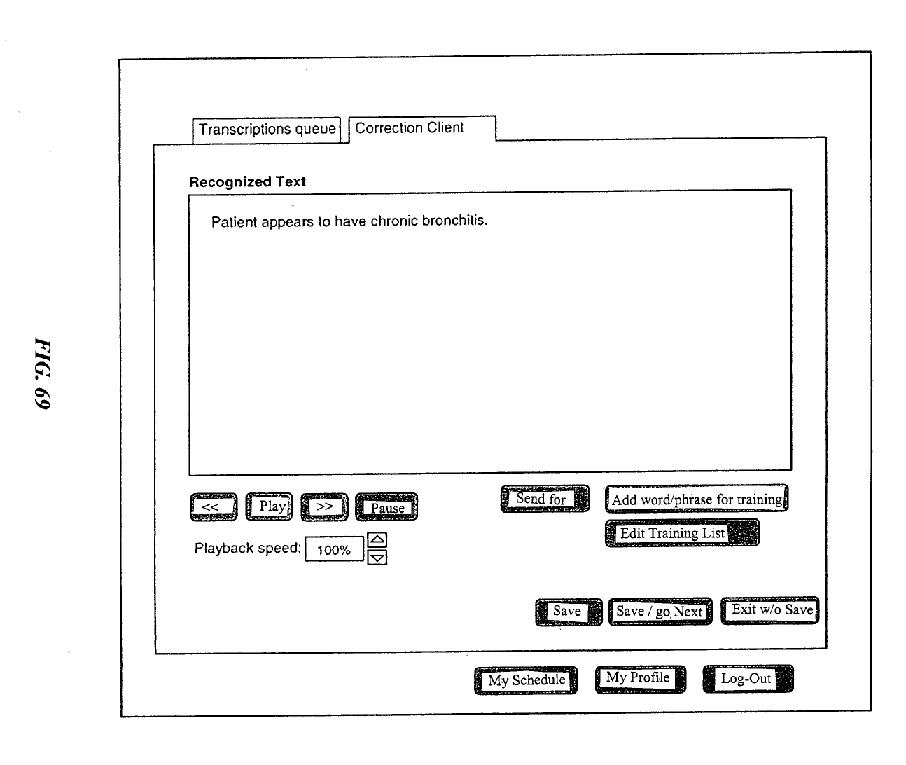

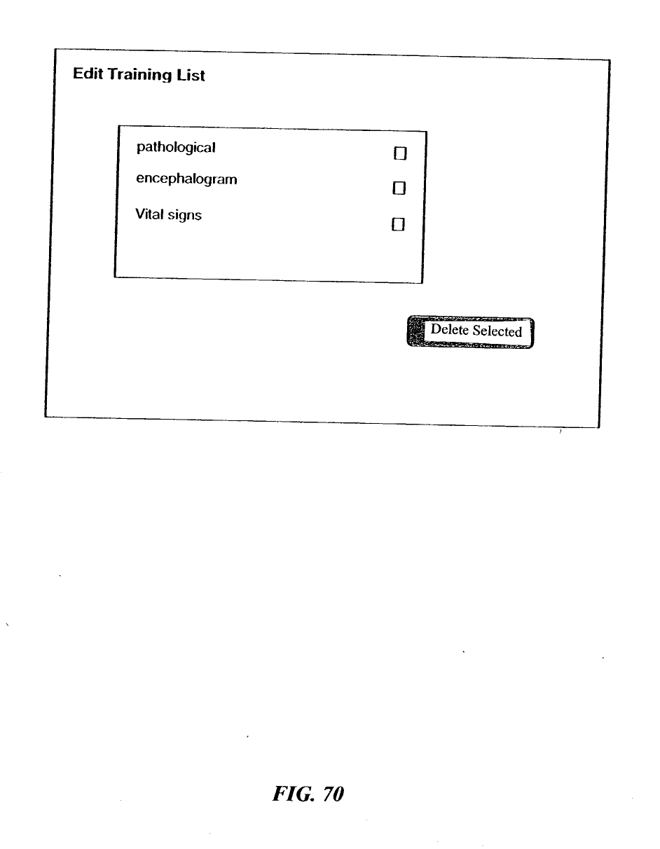

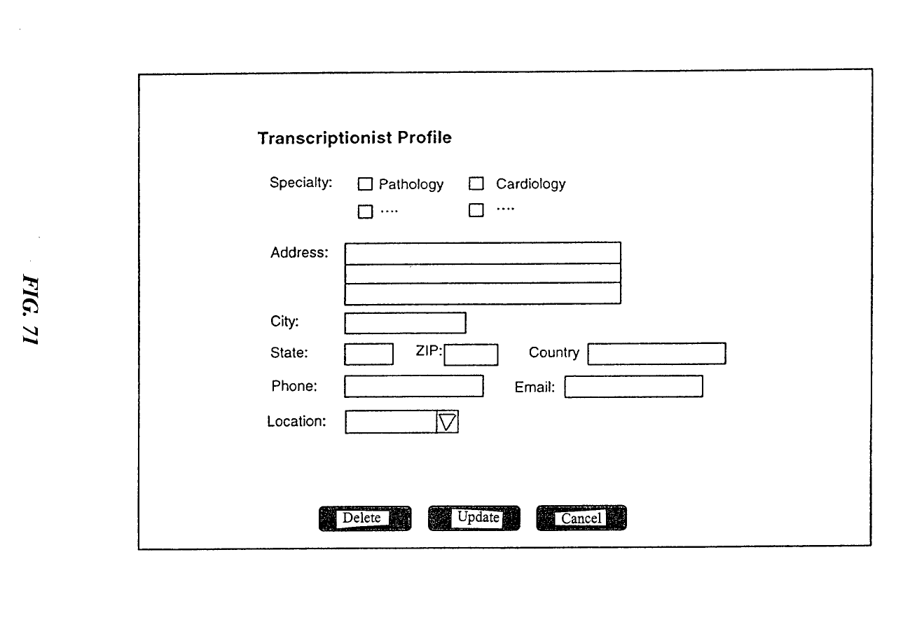

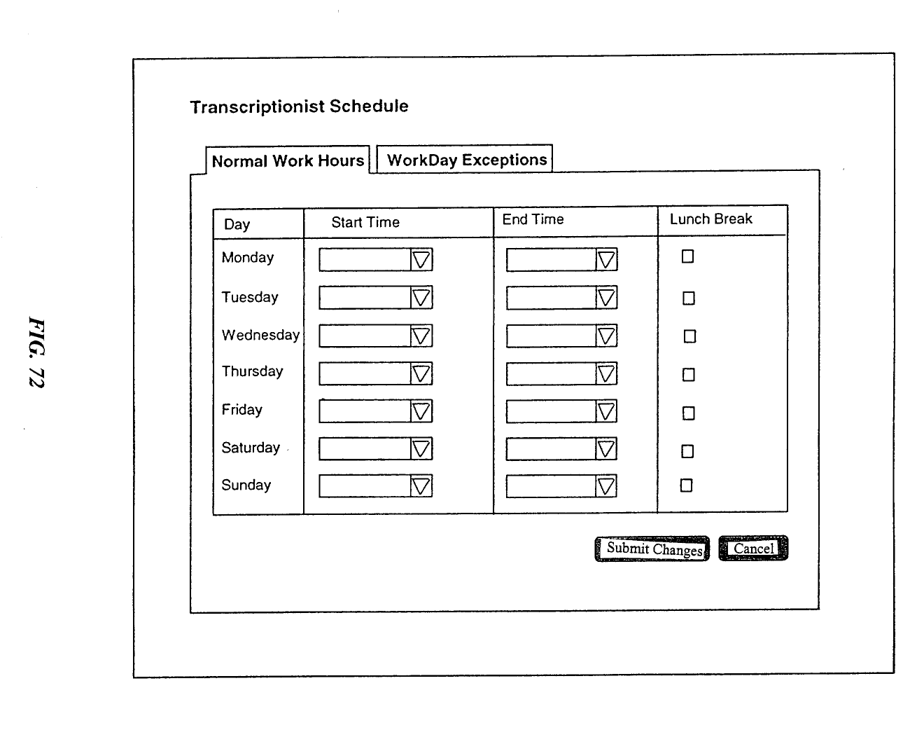

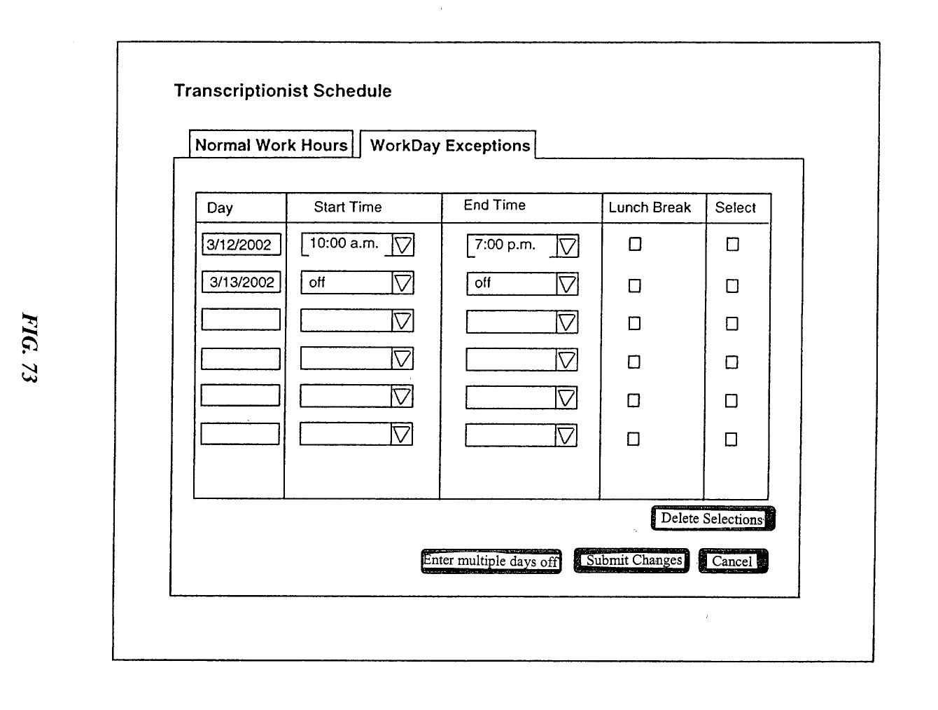

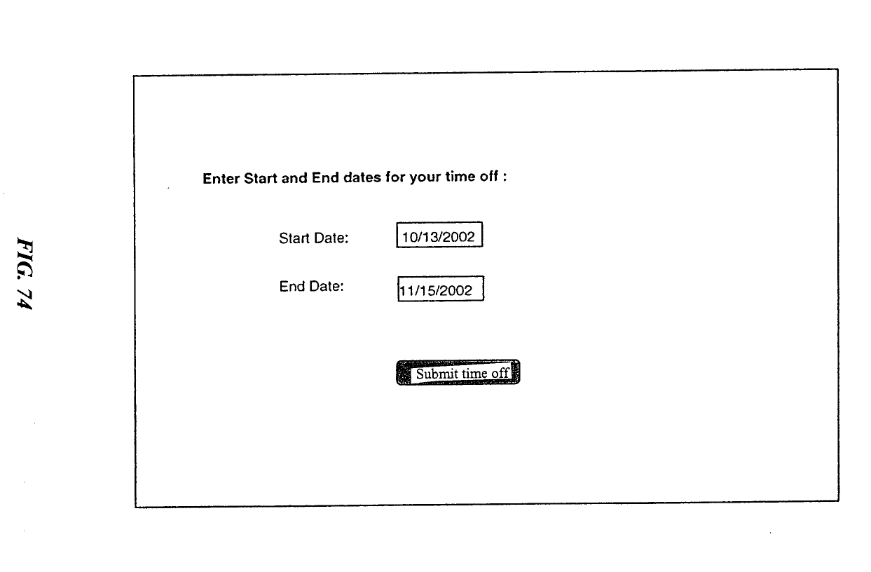

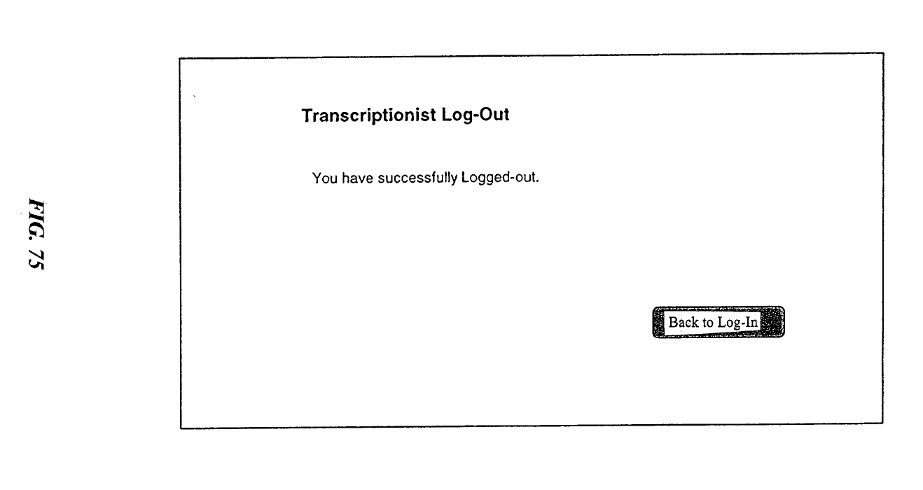

FIGS. 36-75 show how the transcription services are performed according to the present invention, and are believed to be self-explanatory.

In one embodiment of the present invention, a user of a portable user interface device creates and stores a voice file (e.g., .wav file). The data file includes identification and a priority code indicating the urgency of processing the voice file. The voice file and a corresponding data file (.ini file) are placed in a queue of a voice recognition server which generates a text file based on the voice file. Both the voice file and text file are sent to a transcriptionist to edit/correct the text file. The edited/corrected file is then stored in a memory that is accessible by the user of the portable user interface device.

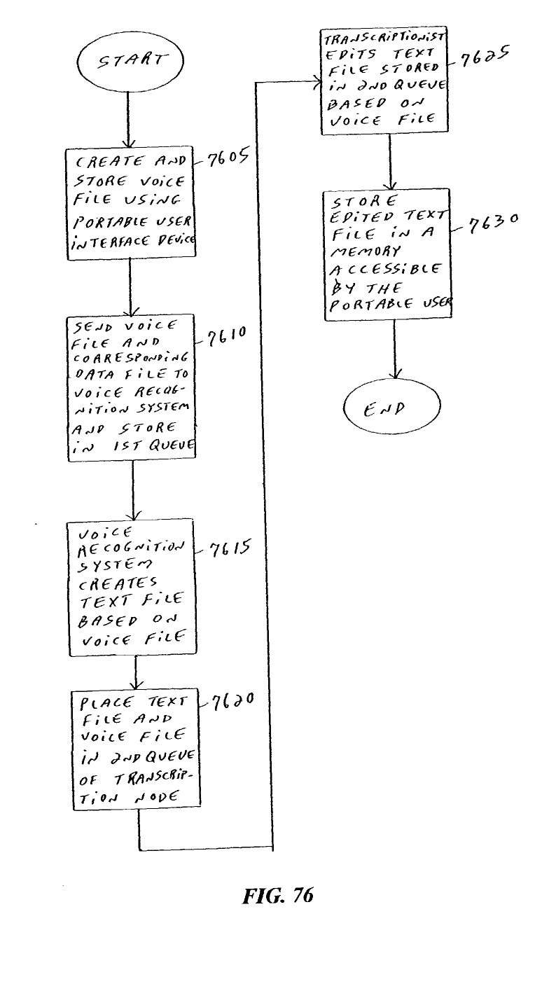

FIG. 76 is a flow chart which summarizes the steps used to transcribe voice files according to one embodiment of the present invention. A health care management system includes a central database, a voice recognition system including a first queue, a transcription service node having a second queue and at least one portable user interface device including a memory. In step 7605, a voice file is created using the portable user interface device. In step 7610, the voice file and a corresponding data file is sent to the voice recognition system and the voice file is placed in the first queue. The data file indicates the priority of the voice file. In step 7615, the voice recognition creates a text file based on the voice file. In step 7620, both the text file and the voice file are placed in the second queue of the transcription node for manual processing by a transcriptionist. In step 7625, the transcriptionist edits the text file stored in the second queue based on the voice file. In step 7630, the edited text file is stored in a memory which is accessible by the portable user interface device. The edited text file is used to train the voice recognition system to avoid errors corrected by the transcriptionist.

A description of the functional requirements of the present invention is located in the Appendix.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer-implemented method for use in a health care management system including a central database and at least one portable user interface device, the central database storing a plurality of medical records associated with a plurality of patients, the portable user interface device including a display and a memory, the method comprising:
(a) storing a subset of the plurality of medical records in the memory of the portable user interface device;
(b) presenting on the display of the portable user interface device a list identifying the patients associated with the subset of medical records;
(c) opening one of the medical records stored in the memory by selecting a patient from the list; and
(d) presenting on the display of the portable user interface device a plurality of selectable windows including (i) at least one activity initiation window for ordering health care activities associated with the selected patient and (ii) an activity status window for presenting a list of the ordered health care activities and the status of each ordered health care activity, wherein after step (a) is executed, the portable user interface device allows a user to manage health care activities performed for the patients associated with the subset of medical records without having to further communicate with the central database.

2. The method of claim 1 wherein data stored in the memory of the portable user interface device is used to update data in the central database.

3. The method of claim 1 wherein the health care activities include placing an order for a prescription.

4. The method of claim 1 wherein the health care activities include placing an order for a diagnostic study.

5. The method of claim 1 wherein the health care activities include placing an order for a laboratory test.

6. The method of claim 1 wherein the health care activities include specifying a consultant to consult with the patient.

7. The method of claim 1 wherein the health care activities include ordering a diet for the patient.

8. The method of claim 1 wherein the health care activities include ordering supplies for the patient.

9. The method of claim 1 wherein the health care activities include sending a notification to a health care provider.

10. The method of claim 1 further comprising:
(e) the user posting a reminder in the activity status window to complete a task at a future time.

11. The method of claim 1 further comprising:
(e) automatically presenting on the display an indicator reminding the user to complete a task at a future time.

12. The method of claim 1 wherein the user modifies the contents of the medical records stored in the memory by making menu selections and/or entering data on one or more of the selectable windows, the method further comprising:
(e) controlling access to specific portions of the medical records based on criteria specified by at least one of the user and the respective patients.

13. The method of claim 1 wherein an ordered health care activity remains on the list until it is verified by the user that the activity has been completed.

14. The method of claim 1 wherein the status is that information required to order a health care activity has not been completed.

15. The method of claim 1 wherein the status is that an order for a health care activity has been completed but not yet released from the portable user interface device.

16. The method of claim 1 wherein the status is that an order for a health care activity has been released from the portable user interface device but no results have been returned to the portable user interface device.

17. The method of claim 1 wherein the status is that only a portion of an ordered health care activity has been completed.

18. The method of claim 1 wherein the status is that an ordered health care activity has been completed.

19. The method of claim 1 wherein the status is that an ordered health care activity has been cancelled.

20. The method of claim 1 further comprising:
(e) the user controlling the portable user interface device to toggle between different ones of the selectable windows presented on the display.

21. A computer-implemented method for use in a health care management system including a central database, a plurality of synchronization servers and a plurality of portable user interface devices, the central database storing a plurality of medical records associated with a plurality of patients, each of the portable user interface devices including a memory and being in communication with only one of the synchronization servers, the method comprising:
(a) distributing a different subset of the plurality of medical records from the central database to each of the synchronization servers; and
(b) each of the synchronization servers storing and refreshing at least a portion of the subset in the memory of the portable user interface device that is currently in communication with the respective synchronization server.

22. A computer-implemented method for use in a health care management system including a central database, a voice recognition system including a first queue, a transcription service node having a second queue and at least one portable user interface device including a memory, the method comprising:
(a) creating a voice file using the portable user interface device;
(b) sending the voice file to the voice recognition system and storing the voice file in the first queue;
(c) the voice recognition system creating a text file based on the voice file; and
(d) placing both the text file and the voice file in the second queue of the transcription node for manual processing by a transcriptionist;
(e) the transcriptionist editing the text file stored in the second queue based on the voice file; and
(f) storing the edited text file in a memory which is accessible by the portable user interface device.

23. The method of claim 22 further comprising:
(g) sending a data file associated with the voice file to the voice recognition system, wherein the data file indicates the priority of the voice file.

24. The method of claim 22 wherein the edited text file is used to train the voice recognition system to avoid errors corrected by the transcriptionist.
